(19) United States
(12) Patent Application Publication
(10) Pub. No.: US 2009/0258700 A1
(43) Pub. Date: Oct. 15, 2009

(54) MUSIC VIDEO GAME WITH CONFIGURABLE INSTRUMENTS AND RECORDING FUNCTIONS

(76) Inventors: Brian Bright, Woodland Hills, CA (US); Travis Chen, Woodland Hills, CA (US); Clark Wen, Woodland Hills, CA (US); Scott Pease, Woodland Hills, CA (US); Joe Pease, Woodland Hills, CA (US); John Devecka, Budd Lake, NJ (US); Michael Chrzanowski, Troy, NY (US)

Correspondence Address: CHRISTIE, PARKER & HALE, LLP, PO BOX 7068, PASADENA, CA, 91109-7068, US

(21) Appl. No.: 12/103,702

(22) Filed: Apr. 15, 2008

(51) Int. Cl. A63F 13/00; A63F 9/24

(52) U.S. Cl. 463/31; 463/35

(57) ABSTRACT

Music video games provide configurable instruments and/or recording functions. In some embodiments users may select an instrument or play, and also select desired characteristics of the instrument. The desired characteristics may include selection of a chord or selection of effects associated with the type of musical instrument. In some embodiments users may record tracks of music using their simulated musical instrument controllers.

### BACKGROUND OF THE INVENTION

The present invention relates generally to video games, and particularly to a music video game with configurable instruments and/or recording functions.

Music related video games may provide enjoyment and entertainment to many. Music video games may allow players to simulate or mimic play of a musical instrument, and do so in the context of playing a song or other work.

Mastering use of a musical instrument may be difficult and time consuming. For some the hurdles in mastering a musical instrument may be too great to overcome. Nevertheless, many who cannot or have not mastered a musical instrument take enjoyment from music and may desire to take a more interactive role with respect to music they enjoy. Music video games may provide such an opportunity, as well as provide additional venues for enjoyment of video games by those who merely relish the challenges in interaction presented by such games. Music video games often allow players to play portions of a song on, for example, a simplified simulated musical instrument, and to do so in a context of directive and possibly competitive game.

Merely playing along with a preexisting song, however, may not encompass the whole of the possible enjoyment of playing a musical instrument, particularly for more advanced game players. In addition, while music games may present a concert-like environment for simulated play of a musical instrument, those who play musical instruments, and particularly professionals, may have a broader gamut of experiences relating to or involving around interactions with musical instruments.

### SUMMARY OF THE INVENTION

The present invention and various aspects provide some music video games with configurable instruments and/or recording functions.

In one aspect the invention provides a method of generating user instruction note tracks for a music based video game, comprising receiving video game controller inputs over time, the video game controller simulating a musical instrument, the video game controller inputs representative of simulated play of the simulated musical instrument; storing an indication of the video game controller inputs, an indication of time of receipt of the video game controller inputs, and a representation of audio associated with the video game controller inputs; generating display information for visual display of a representation of the received video game controller inputs over time.

In a further aspect the invention provides a method of generating a visual representation of video game controller operations for use in a music video game, comprising receiving an input sets from a video game controller simulating a guitar, the video game controller including a plurality of fret inputs and a strum input, the input sets including an activated strum input and activated fret inputs at the time of the activated strum input; storing an indication of the activated fret inputs and a representation of time of activation of the strum input; commanding display of markers in a track, the markers indicative of activated fret inputs, the markers arranged in the track according to time of activated strum input.

In a further aspect the invention provides a method for modifying song information for a music video game, comprising receiving a listing of songs, the listing of songs available from a computer accessible via the Internet; selecting a song from the listing of songs, the selected song including a plurality of editable song tracks; downloading the selected song via the Internet to a local memory; modifying at least one of the plurality of editable song tracks to generate an edited song by operating inputs of a video game controller, with different audio being associated with different inputs and different combinations of inputs of the video game controller; and storing the edited song.

In a further aspect the invention provides a system for providing a recording interface for recording audio information for a video game comprising a display; at least one video game controller; memory, the memory including adjustable audio parameters of simulated instruments associated with each of the at least one video game controllers; a processor configured by program instructions to generate display information of the recording interface, the program instructions including instructions for providing adjustment options for the audio parameters; applying the audio parameters to a sequence of inputs from the at least one video game controller to generate at least one sequence of audio outputs; and providing a recording function for recording the sequence of inputs and the audio parameters.

In a further aspect the invention provides a method of generating a collaborative audio feature in a multiplayer music video game, comprising receiving a selection of a simulated instrument for each of a plurality of video game controllers; adjusting audio parameters associated with each of the plurality of video game controllers; receiving a sequence of input sets from each of the plurality of video game controllers; generating a plurality of audio output sequences, each audio output sequence generated from a sequence of input sets from a one of the plurality of video game controllers and the audio parameters associated with the one of the plurality of video game controllers.

In a further aspect the invention provides a method for configuring a simulated musical instrument in a music based video game system, comprising receiving a selection of a musical instrument based on a signal from a video game controller; mapping audio parameters to video game controller inputs based on the selected musical instrument; presenting options for modifying the audio parameters; receiving requests to implement selected ones of the options; and implementing the selected ones of the options by modifying the mapping of audio parameters to video game controller inputs.

In a further aspect the invention provides a method for generating a simulated guitar chord output in a music based video game, comprising receiving status information of a plurality of fret inputs from a video game controller and an indication of video game controller position; determining a combination of activated fret inputs from the plurality of fret inputs; determining an audio guitar chord output to output based on the combination of activated fret inputs; and modifying the simulated guitar chord output based on the indication of video game controller position.

In a further aspect the invention provides a method for providing audio outputs for a video game, comprising receiving musical instrument related audio parameters associated with a guitar-shaped video game controller, at least some of the audio parameters adjustable using the video game controller; receiving a strum input from the video game controller; receiving an input set comprising status information of a plurality of fret inputs of the video game controller when the strum input was received; and processing the input set and the audio parameters to command generation of an audio output.

These and other aspects of the invention are more fully comprehended upon review of this disclosure.

### BRIEF DESCRIPTION OF THE DRAWINGS

FIG. 1 is an example of a video game system in accordance with aspects of the invention;

FIG. 2 is an example of a block diagram of a video game console processing unit in accordance with aspects of the invention;

FIG. 3 is a screenshot of a simulated instrument configuration and recording screen in accordance with aspects of the invention;

FIG. 4 is a flow diagram of a process of configuring simulated instruments and recording an audio feature in accordance with aspects of the invention;

FIG. 5 is a flow diagram of a process for performing instrument selection and configuration in accordance with aspects of the invention;

FIG. 6 is a flow diagram of an example instrument configuration process in accordance with aspects of the invention;

FIG. 7 is a flow diagram of an audio output generation and recording process in accordance with aspects of the invention;

FIG. 7a is a screenshot of a display showing user instruction information for play of a recorded sequence of video game controller inputs.

FIG. 8 is a mapping of fret input combinations in accordance with aspects of the invention;

FIG. 9 is a modified flow diagram of a process for selecting audio output type in accordance with aspects of the invention;

FIG. 10 is an illustration of a guitar shaped video game controller with position related input in accordance with aspects of the invention;

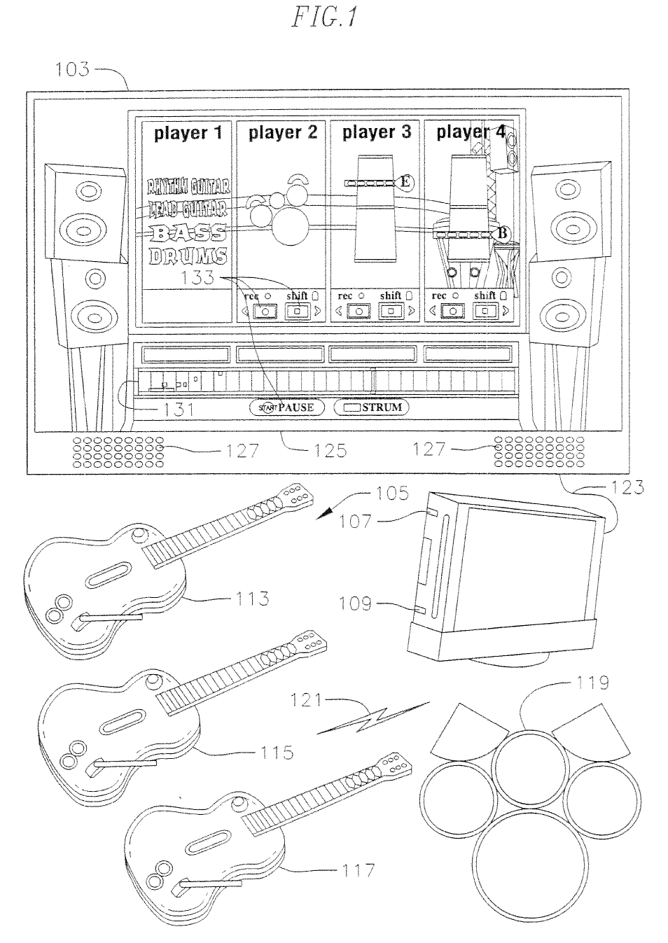

FIG. 1 is a screenshot of an audio track editing screen in accordance with aspects of the invention;

FIG. 12 is a flow diagram of an audio track editing process in accordance with aspects of the invention;

FIG. 13 is a block diagram of a network system including uploading and downloading of audio tracks in accordance with aspects of the invention;

FIG. 14 is a flow diagram of a collaborative editing process in accordance with aspects of the invention;

FIG. 15 is a screenshot of a leaderboard including downloadable songs in accordance with aspects of the invention; and

FIG. 16 is a screenshot of a song preview interface in accordance with aspects of the invention.

### DETAILED DESCRIPTION

FIG. 1 is an example of a video game system in accordance with aspects of the invention. The video game system includes a video game console 101, a display 203, and a plurality of different video game controllers 105. The video game console includes internal circuitry for performing video game related functions, with the circuitry generally including one or more processors, memory, and interface circuitry in most embodiments. The video game console of FIG. 1 includes a power button 107, an eject button 109, and at least one removable memory interface 111. One of the removable memory interfaces is configured to communicate with an external memory source holding video game instructions, for example, a video game CD-ROM.

The video game console may communicate with a variety of video game controllers. In FIG. 1, the video game console is processing instructions for a music/rhythm video game. The video game console receives signals from a first guitar shaped video game controller 113, a second guitar shaped video game controller 115, and a third guitar video game controller 117. The video game console also receives signals from a drum set or similar drum-type video game controller 119. In other embodiments, any combination of guitar shaped video game controllers and drum set video game controllers, or alternatively, other compatible instrument shaped video game controllers, may be used in conjunction with the music/rhythm video game. The different video game controllers may transmit signals to the video game console via wired connections, or through wireless communication 121, as is the case in FIG. 1.

The video game console is coupled to the display via an audio/video cable 123. As illustrated in FIG. 1, the display is a television with a display screen 125 and audio speakers 127. In various embodiments, different types of displays may be used in the system. The display screen shows a screenshot of an instrument adjustment and recording interface in a music/rhythm video game. The screenshot shows status windows 129 for each connected video game controller, displaying various current settings for each video game controller. The screenshot also shows a timeline 131 and a variety of icons, for example, icons 133, for performing selected recording and playback functions. Although the screenshot is from a music/rhythm video game, in various embodiments, similar editing interfaces are applied to other genres of video games.

In the music/rhythm video game embodiment of FIG. 1, the video game console processes a sequence of inputs from each video game controller and saves each input sequence into memory. The processor of the video game console processes information associated with each input in the sequence to assign an audio output for each input, thereby generating an audio feature comprised of a sequence of audio outputs, for example, an audio track for a single instrument in the context of a song. A user using a video game controller may control the generation of the audio feature by the processor by pressing or otherwise manipulating the inputs on the video game controller.

For example, while an audio recording function in the music/rhythm video game of FIG. 1 is active, a user may generate a sequence of inputs from a video game controller. The video game console receives and processes the sequence of inputs, and assigns and generates an audio output for each input based on video game program instructions from either internal memory or the external memory source. The collection of audio outputs represents a audio track created by the video game console based in part on input signals generated by the user operated video game controller. The audio track may stand alone, or be combined with other similarly generated audio tracks to create a collaborative audio feature, for example, a collaborative song.

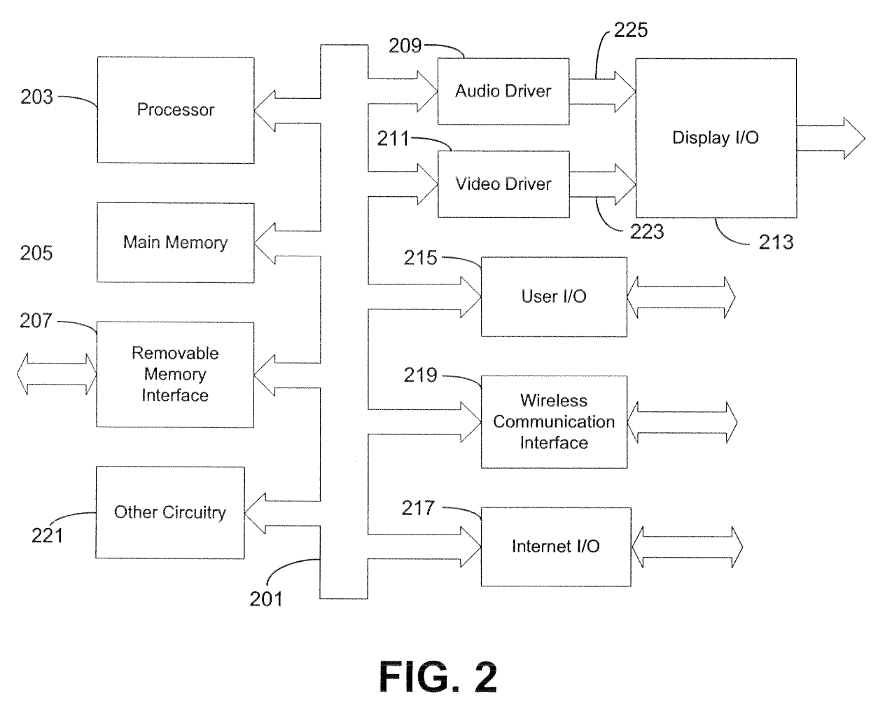

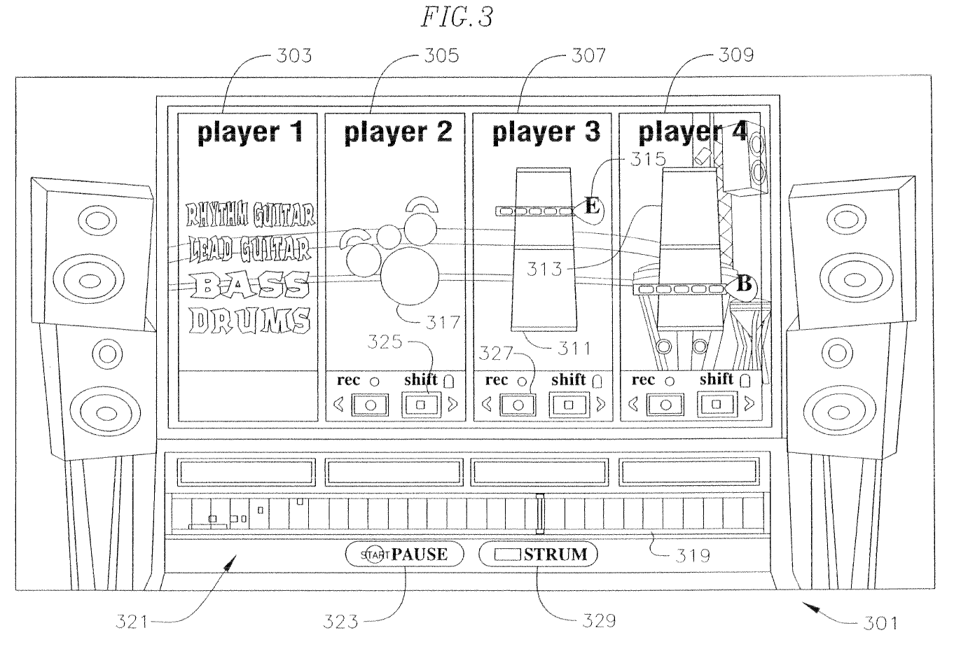

FIG. 2 is an example block diagram of a video game console processing unit in accordance with aspects of the invention. In some embodiments, the processing unit includes a bus 201 interconnecting a processor 203, a main memory 205, at least one removable memory interface 207, an audio driver 209, a video driver 211, a display input/output port 213, a user input/output port 215, an Internet input/output port 217, a wireless communication interface 219, and other circuitry 221. In other embodiments, there may be more or less of each type of device, or different types of devices, associated with the processing units of the respective video game consoles.

In FIG. 2, the processor communicates with each individual component via the bus to execute software instructions to facilitate video game play. In operation, the processor retrieves specific video game instructions from an external memory source inserted into the removable memory interface, such as a video game CD-ROM. The processor processes the video game instructions in accordance with additional program instructions stored in the main memory. The main memory may also be used to store generated data associated with the execution of the video game, which may originate from the processor or other devices connected to the bus. Instructions associated with video game execution may include game play instructions, configuration information, information on video and audio outputs, and instructions for processing user inputs received from video game controllers.

As seen in FIG. 1, the processor is in data communication with a plurality of video game controllers. The video game controllers provide additional inputs to the processing unit, which executes video game play based in part on the video game controller inputs. The video game controllers may communicate to the processor through user input/output ports located on the video game console, or alternatively, may communicate with the video game console through a wireless communication interface.

The processor is also in data communication with a display unit, which displays video game action based on video game instructions executed by the processor. The processor sends audio information associated with video game play to the audio driver, and video information associated with video game play to the video driver. The audio driver generates audio signals using the audio information, and the video driver likewise generates video signals using the video information. The audio and video signals are sent to a display input/output port to be transmitted to the display unit for video and audio presentation. In the embodiment as illustrated in FIG. 2, the video driver and audio driver are coupled to the display input/output port via two dedicated bidirectional buses 223 and 225. In various other embodiments, separate audio and video input/output ports may be used instead of a combined display input/output port.

The processor may also be connected to the Internet via an Internet input/output port. Connection to the Internet may be used to facilitate multiplayer game play with other users in remote locations. In the context of the invention, an Internet connection may also be used to upload audio features created by users to a remote server for other users to access and retrieve. In some embodiments, a wireless communication interface may be used to connect the video game console to the Internet in lieu of a traditional Internet input/output port.

FIG. 3 is a screenshot of a simulated instrument configuration and recording screen in accordance with aspects of the invention. In some embodiments, the instrument configuration and recording screen of FIG. 3 may comprise the main video game play screen in a music/rhythm video game. In other embodiments, the screen may represent an instrument configuration and recording feature, which may be one of a number of different features included in a music/rhythm video game. As features of the invention simulate various different features generally associated with music recording and editing, the screenshot of FIG. 3 includes a backdrop of an entertainment system 301. Other embodiments of the invention may include other types of background images appropriate for different applications.

In the embodiment of FIG. 3, four large instrument panels appear at the top of the screen, with a first instrument panel 303 representing a first simulated instrument, a second instrument panel 305 representing a second simulated instrument, a third instrument panel 307 representing a third simulated instrument, and a fourth instrument panel 309 representing a fourth simulatedinstrument. The instrument panels may be rearranged and resized depending on the number of video game controllers connected to the video game console for video game play. The instrument panels may include information on simulatedinstruments selected, and more detailed information on the simulated instruments based on the type of simulated instrument selected.

In the embodiment of FIG. 3, the third and fourth players have selected to use guitar-type simulated instruments, indicated by guitar chord indicator 311 for the third player and guitar chord indicator 313 for the fourth player. In this embodiment, information displayed for guitar-type simulated instruments include the root note and scale settings for each simulated guitar, and an octave indicator corresponding to the octave range at which each simulated guitar is being played. For example, based on information provided in the third instrument panel, the third player is playing a guitar-type simulated instrument, with a scale having a root note of E 315, and is currently playing at a higher of two indicated octaves. Other information may be provided for other different types of simulated instruments. For example, a second player is playing simulated drums, and rather than guitar specific information, more detailed information on the simulated drum set 317 is instead visualized in the second instrument panel. Further, a first player has yet to select a simulated instrument. A list of simulated instruments available for selection is instead displayed.

A timeline 319 of a song may be provided on the configuration and recording screen. The timeline may be provided, for example, to track the progress of recording of a song, and to indicate the instruments being played at particular times in the song. For example, the timeline in FIG. 3 may indicate that approximately a quarter of a maximum allowable recording duration has been used to create and record a current song, as there exists information on instrument contributions 321 for approximately the first quarter of the timeline. In some embodiments, the timeline may also display more detailed information, for example, specific information on recorded button depressions and additional time stamps.

A plurality of general playback and editing functions are provided. The features may include general playback functions, for example, pause 323, stop 325, and record 327, and may also include simple editing functions, for example, adding a new strum input into the existing recording 329. Some functions may be user specific, while other functions are applied to the entire band or compilation. In most embodiments, while minor editing to created audio tracks may be facilitated through the configuration and recording screen, the screen is generally utilized for instrument configuration and initial recording of audio tracks. A separate more comprehensive editing interface, for example, an advanced recording feature, may also be available, where more complex editing functions may be provided for application to audio tracks created or recorded using the simulated instruments. Certain embodiments of advanced audio track editing interfaces are discussed in detail in conjunction with FIG. 11 and FIG. 12 below.

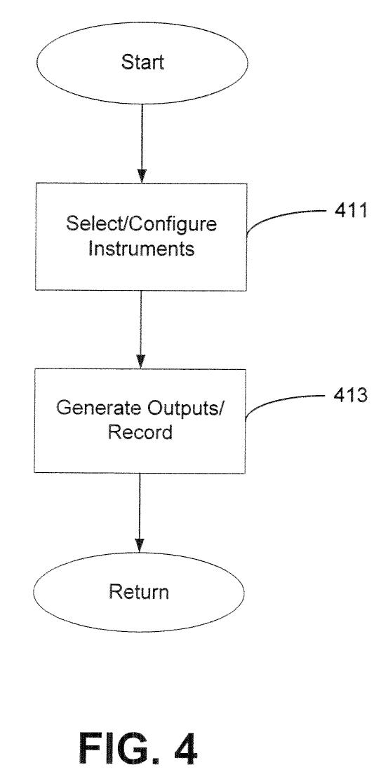

FIG. 4 is a flow diagram of a process of configuring simulated instruments and recording an audio feature with the configured simulated instruments in accordance with aspects of the invention. The process may be performed, for example, by the video game console of FIG. 1. In embodiments of the invention, the screenshot of FIG. 3 represents a user interface during video game play in which the process of FIG. 4 is performed. In other embodiments and other applications, the configurations may be made to various different types of video game controllers, and the process may be used to generate various other types of output material.

In block 411, the process performs instrument selection and configuration. Instrument selection selects simulated output sounds associated with one type of instrument for each video game controller connected to the video game console. Instruments available for selection may include, for example, a drum set, a lead guitar, a bass guitar, and a microphone. In some embodiments, further instruments and devices, for example, a keyboard, turntables, and various midi capable instruments may also be available for selection or connected as auxiliary devices. Instrument configuration provides configuration tools to adjust the audio output parameters of each simulated instrument. Available configuration adjustments may include, for example, application of different chord sets and octave levels of the chord sets, fine tuning aspects of the audio output such as pitch, and adding various effects to the audio outputs.

In block 413, the process performs instrument playing and recording. Sequences of inputs are received from various video game controllers, and the instrument configuration settings associated with each video game controller are applied to the input sequences for each video game controller. A processor of the video game console, in some embodiments, processes the inputs and configuration settings, generally comprising audio parameters for a simulated instrument, based on video game instructions from either an external memory source or a main memory in the video game console to generate a string of audio outputs representing an audio feature, such as an audio track, for signals received from that particular video game controller. If a recording function is activated, the input sequences and configuration information are stored into the main memory.

As an example, the microphone instrument generates outputs based on vocal inputs. A voice from a user is received by the microphone, and outputs are generated based on the pitch changes in the voice. The generated outputs are based on the voice pitches and changes. The generated outputs may be in the form of, for example, an actual voice and/or pitch, phonetics, or vocal rhythm data. Depending on the configuration information, audio outputs, generated by a video game console and based on outputs provided by the microphone, may be one of a variety of synthesized, choir, or keyboard melody audio samples.

In addition to generating an audio feature, the process may also generate an accompanying video feature when the recording function is active. The video feature may correspond to a visual representation of the audio feature, for example, a note track including notes or other symbols corresponding to each of the inputs in a particular input sequence. In some embodiments, the instrument configuration process of block 411 can coincide with the instrument playing and recording process of block 413. In these embodiments, configuration settings or audio parameters associated with one video game controller may be adjusted while other video game controllers are being played.

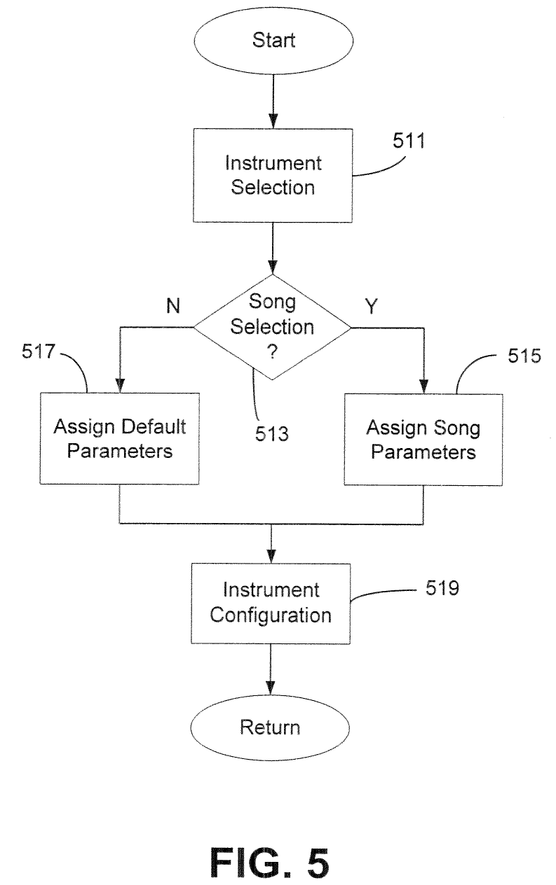

FIG. 5 is a flow diagram of a process for performing instrument selection and configuration in accordance with aspects of the invention. The process may be performed, for example, by a video game console, a processor of a video game console, or some other processor. In some embodiments, the process may be performed in the context of a video game, for example, a music/rhythm video game. In some embodiments, the process may be performed as part of block 411 of the process of FIG. 4. The process may be performed through a user interface similar to the interface described with respect to FIG. 3.

In block 511, the process provides instrument selection functions. Instrument selection assigns a set of output sounds or samples associated with one type of instrument to input signals from each video game controller connected for video game play. In an exemplary embodiment, instruments available for selection include a lead guitar, a rhythm guitar, a bass guitar, a drum set, and a microphone. In various other embodiments, different instruments and their associated audio outputs may also be available for selection. In some embodiments, instrument selection may be unrestricted. For example, a guitar shaped video game controller may be used as a simulated drum set, wherein the various input signals generated by the guitar shaped video game controller may be mapped to different corresponding audio outputs of a drum set. In other embodiments, instrument selection may be limited based on the type of video game controller being used. For example, in these embodiments, the simulated drum set and its associated audio outputs may only be mapped to a drum set video game controller. In these embodiments, a guitar shaped video game controller may still be presented as an option of selecting from a lead guitar, a rhythm guitar, or a bass guitar as its simulated instrument.

In block 513, the process determines if a song has been selected. In some embodiments, a selection of preloaded material may be stored on the external memory source along with the video game instructions. In the context of a music/rhythm video game, the preloaded material may be in the form of preloaded songs or tracks of songs. The preloaded material may also include instrument configuration information for each instrument used to generate the preloaded songs. The process provides the choice of selecting a preloaded song, or of creating an entirely new song. The process may determine an initial configuration for each selected instrument based on whether a preloaded song is selected.

If the process determines that a preloaded song has been selected, the process proceeds to block 515. In block 515, the process assigns initial configuration or audio parameters for each simulated instrument based on a selected song. The parameters associated with each simulated instrument are thus initially configured to match the audio parameters of the instruments which were used in the selected song. For example, audio parameters used in mapping controller inputs to, for example, a video game console, will be configured to match a root note and scale of the corresponding instrument in the selected song. For example, if a video game controller has been identified as simulating drums, the video game console will initially assign video game controller inputs to drum kit sounds which match the drum sounds used in the selected song. Adjustments to the configuration parameters of a selected instrument for a video game controller may be made after the initial settings are applied. However, even without further configuration adjustments, the process provides configuration settings applicable for each simulated instrument, with the configuration settings pre-selected for the song, and in most embodiments having a correspondence to instrument configurations for the song.

Additional features may be associated with selecting a preloaded song. For example, in some embodiments, if the instruments used in the selected song are not all represented by video game controllers, the audio tracks of the other instruments may be generated and played by the video game console based on information stored in the external memory source, while the audio tracks of the selected instruments are either muted, omitted, or played at reduced volume. The process provides for the these tracks to be filled in by the sounds produced responsive to signals generated by the video game console, which are based on input signals received from the video game controllers and the audio parameters stored by the video game console, thereby generating a complete song with tracks from each of the original instruments. In this manner, the video game provides a medium for recreating the entire selected song, including all the instruments, even when there are not enough video game controllers to represent the entire complement of instruments used in the original song.

If the process determines that no preloaded song was selected, the process proceeds to block 517. In block 517, the process assigns a common set of default audio parameters for each selected instrument. The default parameters may be consistent across a roster of selected instruments. For example, the root note and scale of each selected instrument may match with the root note and scales of the other selected instruments, facilitating an initial harmonious free play environment with the video game console generating no key discrepancies between the selected instruments. Some specific examples of common configurations which may be used as default audio parameters for selected instruments are commonly used scales based on the root note of E major or E pentatonic. As was the case in block 515, adjustments to configuration settings, generally audio parameters may be made for each selected instrument after the default audio parameters are applied. The default settings simply provide a viable initial configuration between the selected instruments, preventing generating of signals by the video game console of different sounds for each instrument from clashing with one another.

There may also be additional features associated with not selecting a preloaded song. For example, in some embodiments, a recording function to record newly created audio tracks may only be available when a preloaded song is not selected. This may provide users with added incentive to create new songs rather than simply operate a video game controller to cause a video game console to play over audio tracks of already existing songs. In other embodiments, there may be more configurable settings associated when a preloaded song is not selected. With preloaded songs, the instrument configurations may not be able to stray too far from the initial settings, as the accompanying audio tracks are already preset to certain keys, scales, or octaves. If the configuration settings of particular instruments are adjusted too dramatically from the initial settings for preloaded songs, the sounds caused to be generated by the video game console based on video game controller inputs may not be harmoniously integrated within the context of the preloaded song. The problem does not exist when no song is selected, as there are no audio tracks for video game console generated sounds to conform to or fit in with.

In block 519, the process adjusts the initial configuration settings. In many embodiments users are provided options for adjusting configuration settings, and the process receives and processes user inputs to change the configuration settings as requested.

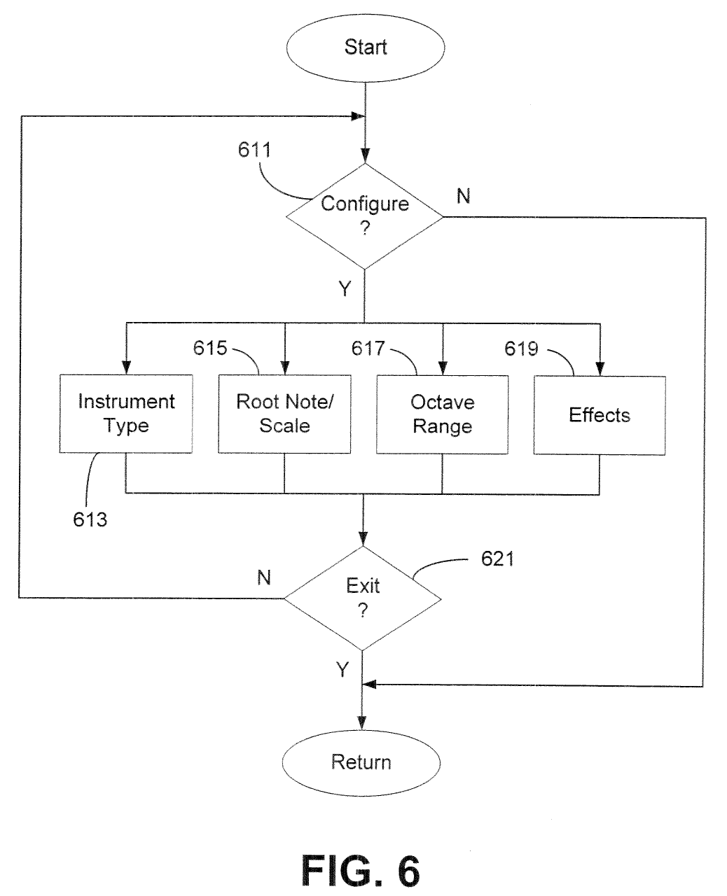

FIG. 6 is a flow diagram of an example instrument configuration process in accordance with aspects of the invention. The process may be performed, for example, by a video game console, a processor of a video game console, or some other processor. In most embodiments, the instrument configuration process follows the instrument selection process. In some embodiments, the instrument configuration process may be revisited or re-accessed without repeating the instrument selection process, for example, making configuration changes to an already selected instrument during video game play. In some embodiments, the instrument configuration process of FIG. 6 is performed as part of processing of block 519 of FIG. 5.

In block 611, the process determines which configuration settings or audio parameters of the selected instrument to adjust. As illustrated in FIG. 6, available configuration settings may include instrument type, root note and scale settings, octave ranges, and application of different effects. However, in some embodiments each type of selectable instrument has a unique set of configurable settings or adjustable audio parameters available, and some of the settings listed above may not be configurable for certain types of selectable instruments. As discussed above, adjustable settings for each instrument may also be dependent on whether a preloaded song is initially selected. In other embodiments, fewer, additional, or different configurable settings or adjustable audio parameters may be available to adjust. Specific information pertaining to the settings for each type of instrument may be communicated through the user interface. If no configuration settings or audio parameters are changed, the instrument selection and configuration process ends, and the process returns.

If the process determines that the instrument type configuration setting or parameters has been selected for adjustment, the process proceeds to block 613. In block 613, the process provides different instrument types for selection. In embodiments where different types of guitars are selectable instruments, instrument type configuration may include selection of a chord set for each instrument. For the different types of guitars, this may include a predefined set of guitar samples including sets of chords which may be mapped by for example the video game console to different fret input combinations on each video game controller. Preselected chords may be applied to each fret input combination based on a predefined root note and scale when a certain chord set is selected. In embodiments where drums are available for selection, instrument type selection may include selection of different audio sample sets associated with various different drum kits.

Instrument type configuration may also include different set types, in other words, various different types of output sounds which may be generated from a particular chord set or drum kit. For example, on guitars, there may be a number of different versions or audio samples associated by a video game console with a single chord or fret combination. Some examples of different guitar output sounds which may be commanded to be generated by a video game consolebased on a single fret input combination may be clean output, distorted output, fingered notes, picked notes, sustained notes, palm muted notes, power chords and barre chords. In some embodiments, a selection of predefined set types may also be available, the predefined set types emulating various famous musicians. A selection of audio parameters corresponding to famous drum kit types may also be available, for example, a drum kit type with audio outputs emulating a drum set used by one of a number of famous drummers. In some embodiments, famous set types may only be available after completing milestones during video game play, or may only be available for purchase or download through special servers.

If the process determines that the root note or scale configurations have been selected for adjustment, the process proceeds to block 615. In block 615, the process provides for adjustment of the root note and scale configurations of each selected instrument. In embodiments discussed with relation to the invention, root note and scale adjustments may only apply to guitar settings, and not to drum or microphone settings. In other embodiments where different instruments with variable scales are selected, the process may apply to those instruments with variable scales. The process may be much like the instrument type configuration adjustments of block 613, with the major difference being that rather than changing instrument outputs on a set-by-set basis, configurations may instead be changed on a note-by-note basis, allowing for a wider range of flexibility and customizability.

Assigning a root note to a selected instrument initially adjusts the remaining notes in the scale to correspond to the root note. This may affect, for example, the notes mapped to fret input combinations on the video game controller associated with outputting a typical music scale. Further, adjusting the scale may change the individual notes mapped by the video game console to the fret input combinations to match different scales without changing the root note. Different types of scales may include, for example, pentatonic, chromatic, major scale, minor scale, and blues, among others. While the root note may remain the same, the remaining notes defining the scale associated with the root note may be adjusted to match the preferences of a user using the video game controller. In some embodiments, custom scales may also be created. In these embodiments, each note associated with an individual button combination may be customizable, thereby creating a completely customizable video game console audio output set for each video game controller.

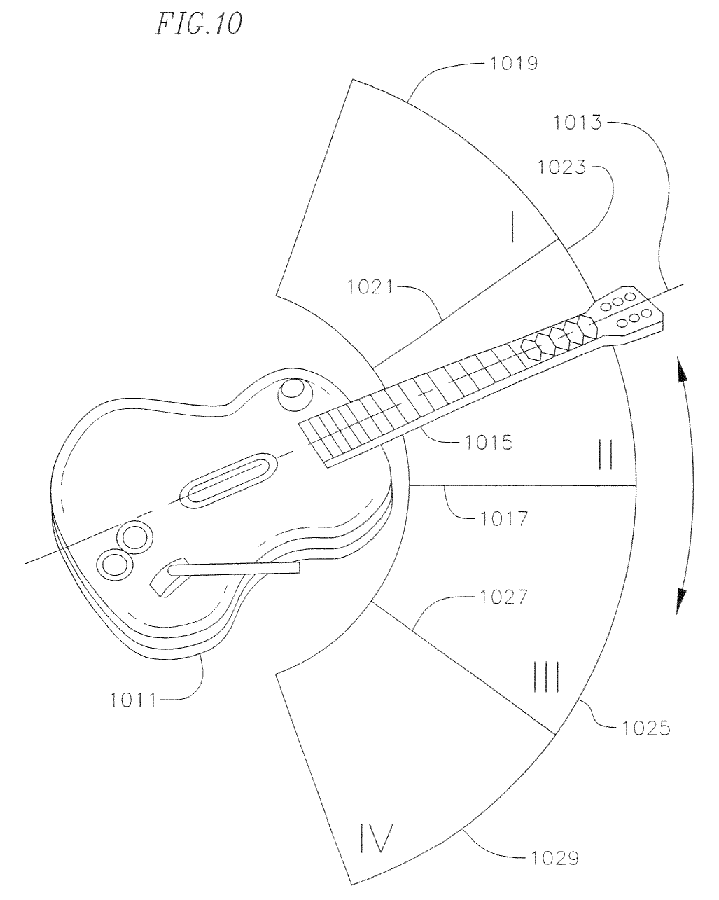

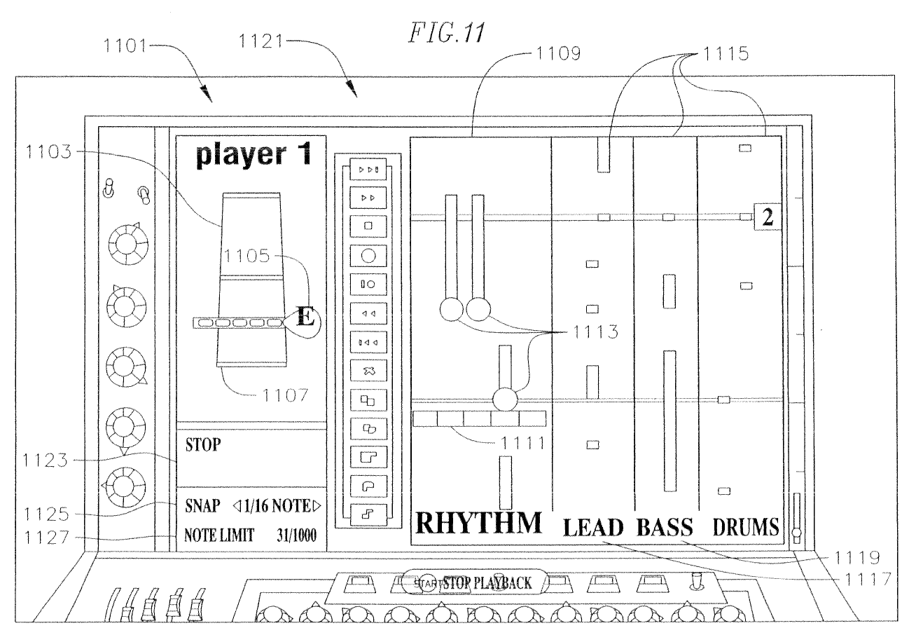

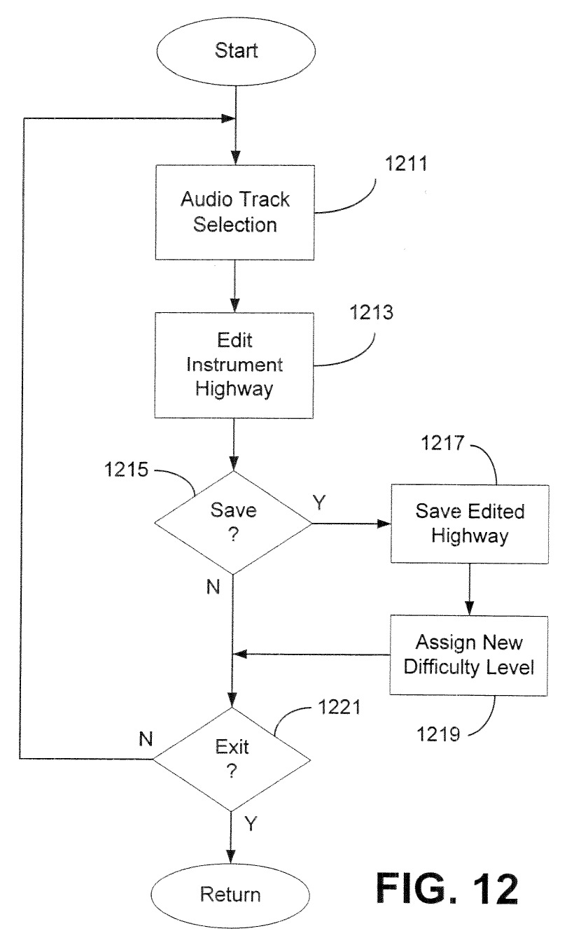

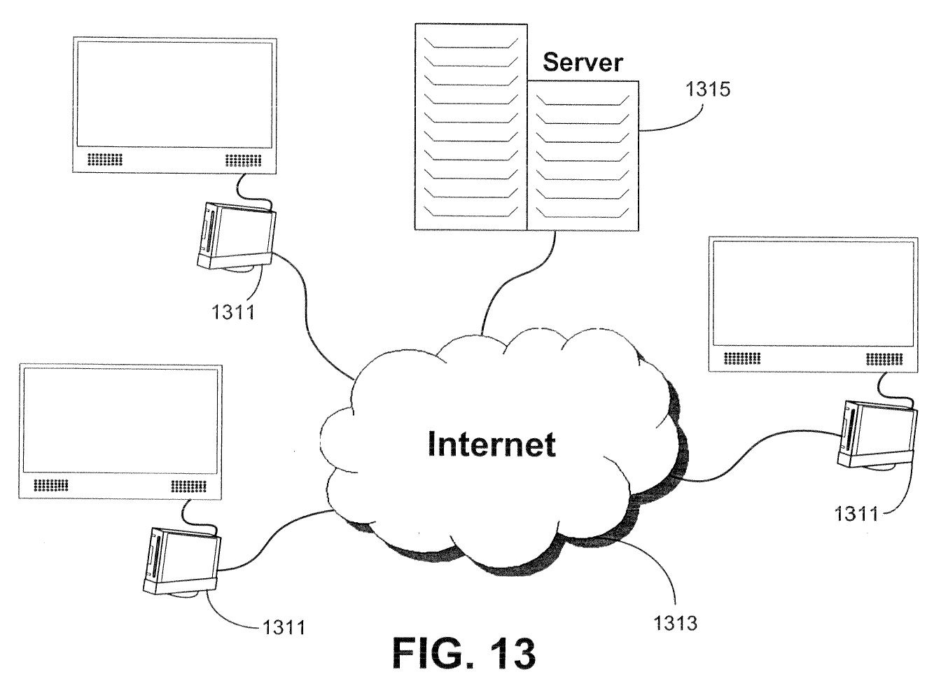

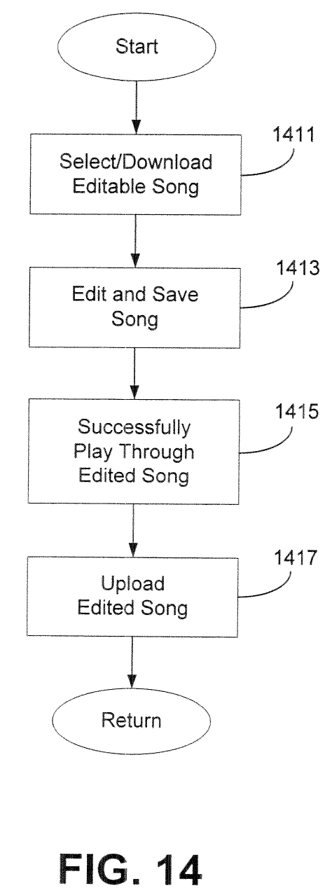

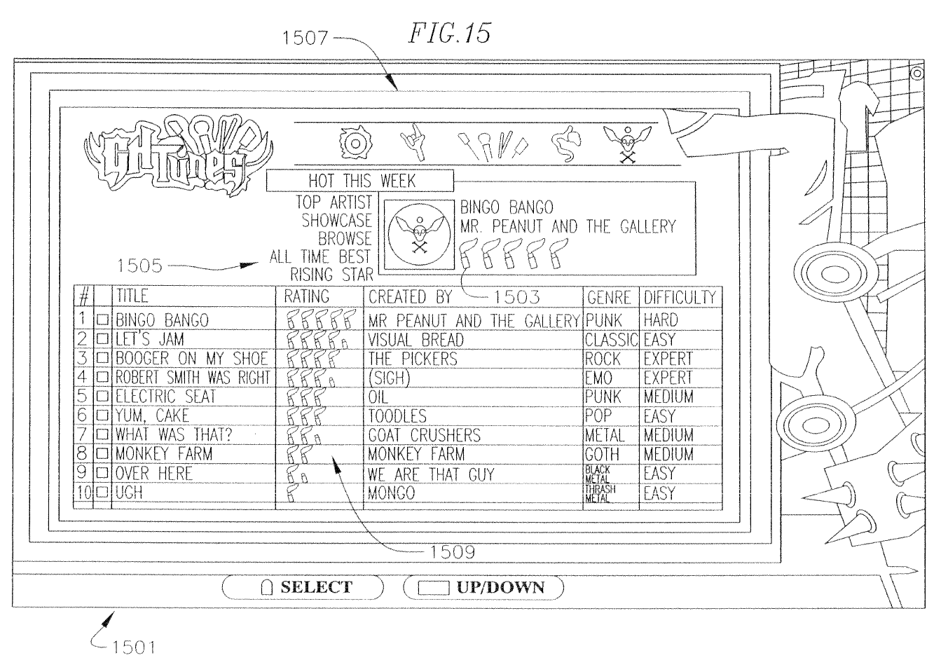

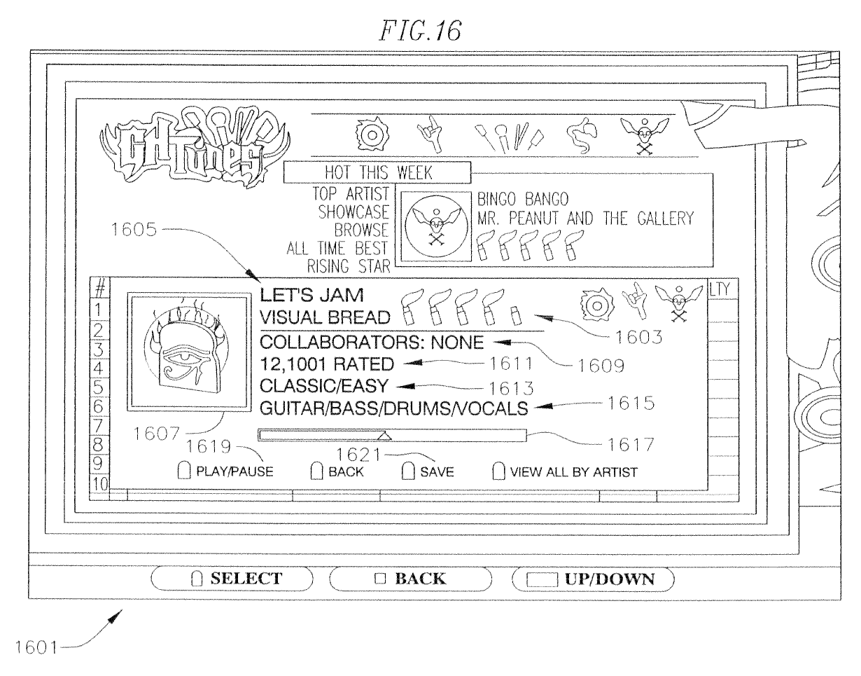

In block 617, the process provides for adjustments to the octave configuration of each selected instrument. In some embodiments, only a limited number of video game controller button combinations are mapped by the video game console to traditional chord outputs. In these embodiments, there may only be enough button configurations available for the video game console to map one or two octaves of a particular chord set. Providing for adjustments to octave configurations is one way of resolving the issue, as the video game console may provide audio parameter mapping for a selected instrument to a low octave range or a high octave range, depending on the desired integration of the instrument into the song. In some embodiments, there may be three octave ranges to select from, for example, a low octave range, a middle octave range, and a high octave range. The video game may allow for selection of one or two octave ranges to be active at any particular instance. For example, in embodiments where two octave ranges may be selected, the possible combinations may be low-middle, middle-high, or low-high. If a deactivated octave range is desired during game play, some embodiments may provide for octave configuration adjustments while the instrument is being played, thereby providing access to all available octave ranges. In some embodiments, available octave ranges may further be expanded by using an accelerometer or similar output in the video game controller to detect instrument tilt angle. Such a process is further described with respect to FIG. 10 below.

In block 619, the process provides for effects adjustments for the audio outputs associated with each selected instrument. Effects configuration settings available for each type of selectable instrument may be different. For example, effects which may be adjusted on a simulated guitar may include pick slide and finger slide characteristics, distortion levels, harmonics, and vibrato outputs. Some examples of effects on a simulated drum set are reverb, delay, and compression effects settings. In some embodiments, available effects settings may be modeled after familiar simulated instrument effects programs on the market. These embodiments may provide for adjustments to distortion levels of output chords, power settings, and volume controls, among other configuration settings associated with amplifiers and simulated amplifiers. For example, for a guitar-type instrument, more specific available effects which may be applied to a selected instrument may include reverb, chorus, and pitch shifting. Reverb may add an echoing effect to an audio output. Chorus effects synthesize similar sounds, and output the synthesized sounds together when a note is played, giving the note a chorus-like effect. Pitch shifting utilizes, for example, an amplifier to control pitch deflections of an audio output. Adjustable effects may be arranged as predefined configurable effect sets, or may alternatively be arranged so that minor adjustments may be made to various individual effect parameters.

The wide array of configuration and audio parameter settings available provide for selectable instruments which can be customized and personalized for a wide range of music types and applications. The instrument type and root note/scale settings provide a variety of different chord sets to apply to each selectable instrument. Octave and effects configurations further provide for a great deal of variation even within each selected set of chords, thereby facilitating the creation of simulated instrument output sets for all different types of music genres and preferences.

After adjustments to a particular configuration setting have been completed, the process proceeds to block 621 and determines whether to exit the instrument configuration process, or to continue making adjustments to the same or a different configuration setting. If the process determines to continue configuration adjustments, the process returns to block 611, where further configuration adjustments may be made to the selected instrument. If the process determines to exit the instrument configuration process, the process returns.

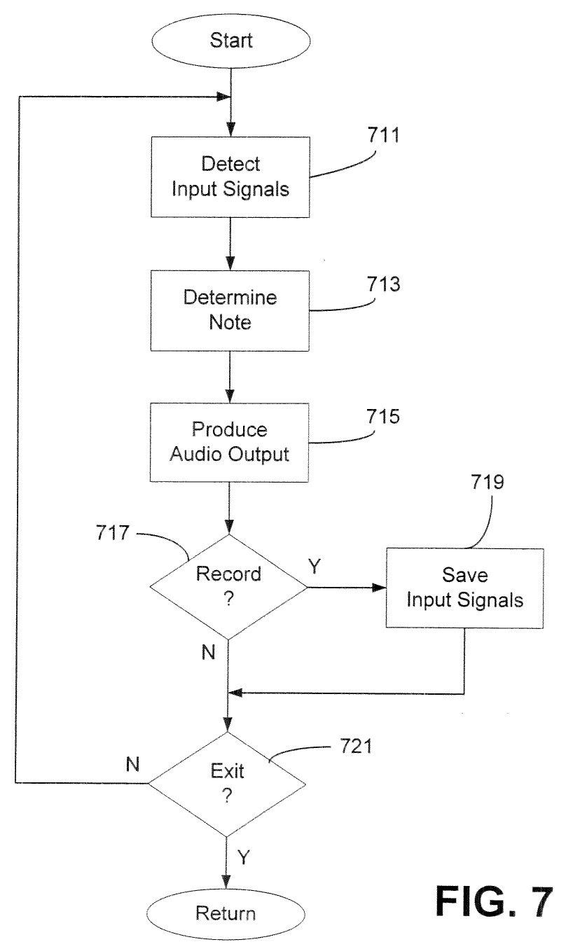

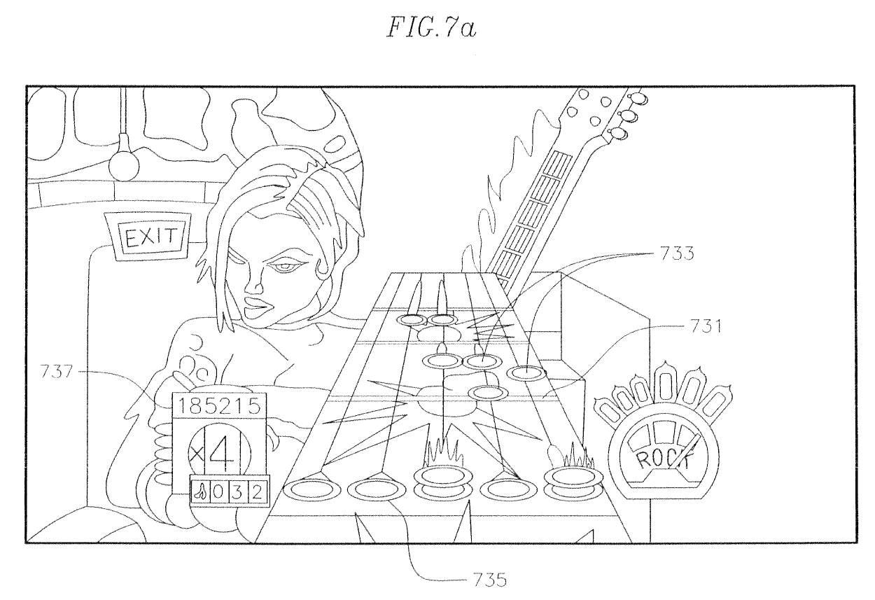

FIG. 7 is a flow diagram of an audio output generation and recording process in accordance with aspects of the invention. In some embodiments, the process may be performed in the context of a music/rhythm video game. In some embodiments, the process may be performed as a part of block 413 of the process of FIG. 4. The process of FIG. 7 may be performed, for example, by a video game console, a processor of a video game console, or some other processor.

In block 711, the process detects input signals from a video game controller. The signals may include, for example, a strum input from a guitar shaped video game controller, or for example, a strike on a drum head input in a drum set. For guitar shaped video game controllers, strums may be detected when, for example, a strum input on the video game controller is actuated by depression or displacement. In some embodiments, such an actuation may represent the strumming of a note on a guitar. In some embodiments, actuation of the strum input on the video game controller may activate an input set generation or information generation process in a processing unit or control circuitry local to the video game controller. In other embodiments, a strum signal may be sent directly to a video game console from the video game controller indicating activation of the strum input on the video game controller.

The input signal may be generated from, for example, a strike of a drum head in a drum set. The strike of a drum head may simulate the striking of an actual drum or a cymbal in a real drum set, or may be associated with the generation of one of various different types of sample sounds, for example, guitar sounds, vocal sounds, or different types of sound effects. In some embodiments, an input signal generated from a drum head strike may include information associated with the strike, for example, which drum head was struck, or for example, the intensity of the strike.

In block 713, the process determines a note (or chord or sound or sequence of sounds, sometimes referred to as a “note”) based on the input signals. For a guitar shaped video game controller, the input signals may include information on the time of the strum input in the context of a song being recorded, and the status of different input sources from the video game controller at the time of the strum input activation. In some embodiments, the direction of strum displacement or activation may also be included. In these embodiments, different strum directions may generate slightly different output sounds, representing the difference in sounds produced between a downward strum and an upward strum on a real guitar. The status of the other different input sources from the video game controller may include, for example, the combination of fret inputs and additional inputs activated at the time of the strum, and for example, the tilt angle of the video game controller at the time of the strum. Various other embodiments that generate outputs based on other input devices, such as drum sets, may include different input signals holding different types of information. For example, drum inputs devices which detect strike intensity may generate input signals which a video game console processes differently, leading to, for example, the same audio output with different volume or reverberation characteristics.

The process may also apply configuration settings and modifications associated with the selected simulated instrument to each determined note. In some embodiments, the applied configuration settings may be the instrument configuration settings adjusted earlier in accordance with the instrument configuration process of FIG. 6. In other embodiments, the configuration settings may be preselected settings based on, for example, the selection of a preloaded song, or for example, a particular genre of music being emulated. Application of the configuration settings and modifications to each determined note may also include, for example, what effects are to be applied to each determined note. The processor of the video game console may apply the configuration settings and modifications based on the input signals upon receipt of the input signals. The processor may alternatively store each set of input signals into memory, and retrieve sets of input signals as needed when the processor later requests generation of the audio outputs associated, by configuration settings, generally audio parameters, with particular sets of input signals.

In block 715, the process generates audio outputs based on the determined note. The processor of the video game console creates an audio generation command from the set of input signals and configuration and modification settings, and sends the audio generation command to an audio driver, for example, the audio driver as illustrated in FIG. 2. The audio driver processes the audio generation command and converts the command into an audio output corresponding to the input set with the applied configuration settings. The audio driver sends the audio output to an input-output port connected to speakers. The speakers may be speakers built into a display unit, for example, the speakers as illustrated in FIG. 1, or the speakers may be in another form, for example, standalone speakers.

In many embodiments of the invention, the generated audio output may be held, for example, a note which is sustained for several seconds. In these embodiments, the held audio output may be altered or modified in different ways while held as well. In some of these embodiments, hammer-ons and pull-offs may be performed. Hammer-ons and pull-offs are performed on a real guitar by pushing down on or letting go of a string or chord while a strummed chord is reverberating, producing a different note or chord. On the video game controller, a simulated hammer on or pull off may be performed by, for example, switching fret input combinations while a note is being held. In embodiments where the video game controller includes an accelerometer, a vibrato effect may be applied to a held note if a video game console receives a signal from the accelerometer indicating light shaking of the video game controller by a user. In embodiments where the video game controller includes a tremolo arm or a whammy bar, a similar vibrato or pitch shift effect may be applied by deflecting the tremolo arm or whammy bar while a note is being held. In some embodiments, a palm mute input device may also be available, for example, to direct the video game console to apply a muting effect to a note before or after it has been played. If a palm mute input device is activated while a note is being held, the held note may, for example, decrease in volume, or for example, have a muted audio effect applied to it. A variety of other different input devices may be found on the video game controllers, and may direct the video game console to generate different types of audio outputs. For example, additional analog or digital inputs may be found on either the neck or the body of a guitar shaped video game controller and expand the ways in which the video game controller may be operated.

In block 717, the process determines whether a recording function is activated. If the process determines the recording function is activated, the process proceeds to block 719 to save information associated with recordation. If the process determines the recording function is not activated, the process proceeds to block 721, where the process determines whether to exit.

In block 719, the process records, or saves, the information pertaining to the input signals and configuration and modification settings. The information may include, for example, the time of the note (referring also to chords or other sound or sequence of sounds) in the context of video game play, the status of the various video game controller input sources, and various configuration and modification settings associated with the note. Accordingly, the saved information includes information of or representing video game controller inputs, relative time of the inputs, and sound or sounds associated with the inputs. Further, in some embodiments, times of the audio outputs may be quantized to the nearest beat or fraction of a beat to generate a more precisely or uniformly timed audio feature. The processor directs the information to memory, for example, a main memory associated with the video game console. In some embodiments, information may be partially or fully processed before storage into the main memory. For example, rather than the set of input signals and configuration and modification settings, what is stored into memory may instead be the audio generation command. Consequently, if a collection of input signals is generated and stored into memory, the collection may aggregately represent an audio feature, for example, an audio track comprising a sequence of audio outputs from a single instrument. A collaboration including various audio tracks may then constitute a complete song compilation, with each audio track representing the audio output from a different instrument.

In block 721, the process determines whether to exit the audio output generation and recording process. If the process determines to continue audio output generation, the process returns to block 711 and awaits detection of the next set of input signals. If the process determines to exit audio output generation, the process returns.

A visual note track may also be generated, the note track including visual displays of the sequence of video game controller inputs and relative times of each video game controller input of the sequence of video game controller inputs. The visual note track may include, for example, markers which move with or along the track, the markers serving as instructions as to how to operate the associated video game controller to generate input signals consistent with recreation of the audio feature. For example, the markers may pass through or reach a predefined area while moving with the note track, instructing users to operate the video game controller in a certain way at the time the markers pass through or reach the predefined area. FIG. 7a shows a screenshot with a note track 731. Markers, for example markers 733, are displayed on the note track, and move along the note track towards a NOW area 735. Each of the markers represent a particular input on a video game controller, for example a guitar shaped video game controller or a drum set shaped video game controller, and the markers provide user instruction information. When the markers reach the NOW area a user is to, for example, strike certain drum heads of a drum set shaped video game controller or strum a strum bar of a guitar shaped video game controller while having depressed fret button inputs indicated by the markers. In many embodiments sound associated with the video game controller inputs is provided if the user complies with the user instruction information. In addition, a score 737 may be displayed, with the score indicating extent of compliance with the user instruction information.

In FIG. 7a user instructions are provided for a single video game controller. In many embodiments, however, a plurality of tracks may be recorded, with each track representative of a sequence of inputs for different video game controllers. In some embodiments, for example, tracks may be provided for a guitar shaped video game controller, a drum set shaped video game controller, or other video game controllers. In some instances, it may be desirable to allow for recording of tracks for a plurality of guitar shaped video game controllers, which may be representative of different types of guitars or different applications of similar guitar. In some such embodiments some of the tracks for different video game controllers may be merged, in some embodiments with some of the inputs removed from the input sequences, to allow for later play in scenarios where not all of the tracks are normally provided for game play. For example, game play may only allow for a limited number of guitar type video game controllers, and a track for a rhythm guitar and a lead guitar may be merged.

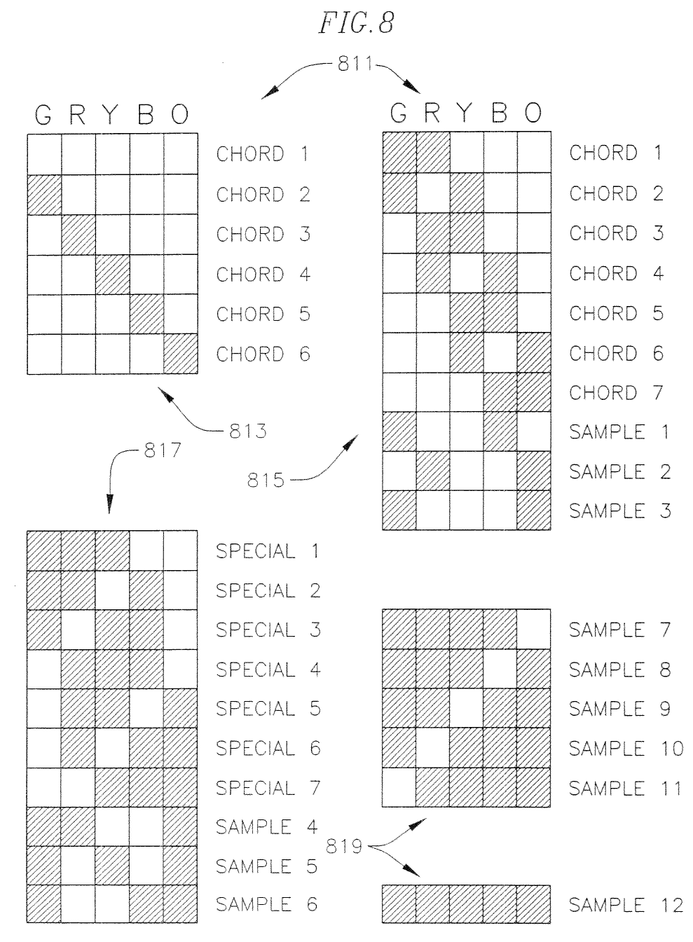

FIG. 8 is a mapping of fret input combinations for a guitar shaped video game controller with five fret inputs in accordance with aspects of the invention. Similar mappings may be established for other types of simulated instruments, for example, drum-type instruments or video game controllers. In some embodiments, the five fret inputs are color coded, for example, the available fret colors for the embodiment represented in FIG. 8 are green, red, yellow, blue, and orange, as represented by the G, R, Y, B, and O labels 811 located at the top of the tables. Each letter corresponds to a different colored fret input, each colored fret input represented in the tables as a separate column. The tables are arranged so that each horizontal row represents a fret input combination, where the shaded boxes represent the activated fret inputs for each combination.

The top left table 813 shows the fret input combinations with either none or one fret input activated. In the embodiment of FIG. 8, when no fret inputs are activated, the output is chord 1. Likewise, when one of the fret inputs is activated, the output is one of chord 2 through chord 6. There are only six fret combinations available with zero or one fret activated, while there are seven notes in an octave of a typical scale. Therefore, the set of chords represented by this fret combination set does not correlate to a full octave of chords. Consequently, in many embodiments, the chord set represented by the zero/one fret combinations is only used for beginner users or in training exercises before graduating to more complex fret combinations. In some embodiments, the range of the chords is expanded when video game controller tilt is factored in. Again, tilt input will be discussed with respect to FIG. 10.

The top right table 815 shows the possible fret input combinations using two fret inputs. The first seven of these fret input combinations are combinations with a maximum of one fret button gap between the two activated fret inputs. As the two activated fret inputs are relatively close to each other for these combinations, the first seven combinations can be considered the easier two fret combinations. As such, these seven combinations are assigned regular chord outputs 1 through 7, thereby creating a complete octave of chord outputs. As these seven fret combinations are easier to execute than the other three combinations in the group, it is desirable to assign the regular chords to these combinations, so as to utilize the easier combinations more frequently. Note also that the first six of these fret combinations generate the same chord outputs as the six zero/one fret combinations. The octave range may either be altered through the instrument configuration process of FIG. 6, or may be changed through the tilt input of the video game controllers. In some embodiments, there may be alternative methods of adjusting the octave range. For example, in some embodiments, other input devices on the video game controller may be designated for octave adjustments, and in other embodiments, a peripheral device, such as a foot pedal, may communicate with the video game controller, and be used to change a current octave range during video game play. Some embodiments of the video game controller may provide additional ports to connect similar peripheral devices and expand the utility of the invention. The remaining three fret combinations in this group have a wider gap between the two activated fret inputs, and may thus be categorized as the more difficult two fret combinations. Each of the more difficult fret combinations may be assigned special outputs, for example, special audio samples.

The bottom left 817 table shows the possible fret input combinations using three fret inputs. Generally, as the number of fret inputs activated increases, the more difficult the combinations are to execute. Therefore, the two fret combinations are considered more difficult to execute than the zero/one fret combinations, and the three fret combinations are likewise considered more difficult to execute than the two fret combinations. As was the case with the two fret combinations, there is also a category of seven easier three fret combinations. The seven easier combinations are those combinations which do not require the simultaneous activation of the two farthest fret inputs, those being the green and orange fret inputs in the embodiment of FIG. 8. Therefore, in the embodiment of FIG. 8, these seven combinations are assigned a complete octave of special chords. The special chords assigned to these seven fret combinations may be chords utilized less frequently than the regular chords represented by the two fret combinations discussed above. For example, a minor chord set may be assigned to these seven combinations, or for example, an octave of acoustic chords may be assigned to the combinations. And as with the two fret combination arrangement, the three more difficult three fret combinations may also be assigned special outputs, such as special audio samples.

The remaining possible fret input combinations 819 are represented in the bottom right portion of FIG. 7. These fret input combinations involve activating either four or all five of the fret inputs. As these fret combinations are difficult to execute during video game play, they may all be assigned special outputs, such as special audio samples.

Therefore, in the embodiment as illustrated in FIG. 7, there are twelve free slots available for assigning special audio samples. Examples of special audio samples may include pick slides, dive bombs, fret noises, and finger releases, among others. Further, while a preselected regular chord set and special chord set may initially be assigned to the input combinations as presented, it is appreciated that in most embodiments, the preselected chord sets are configurable, either on a set-by-set basis or on an individual chord-by-chord basis. These embodiments therefore allow for a great deal of customizability pertaining to mapping output sounds associated with each fret input combination.

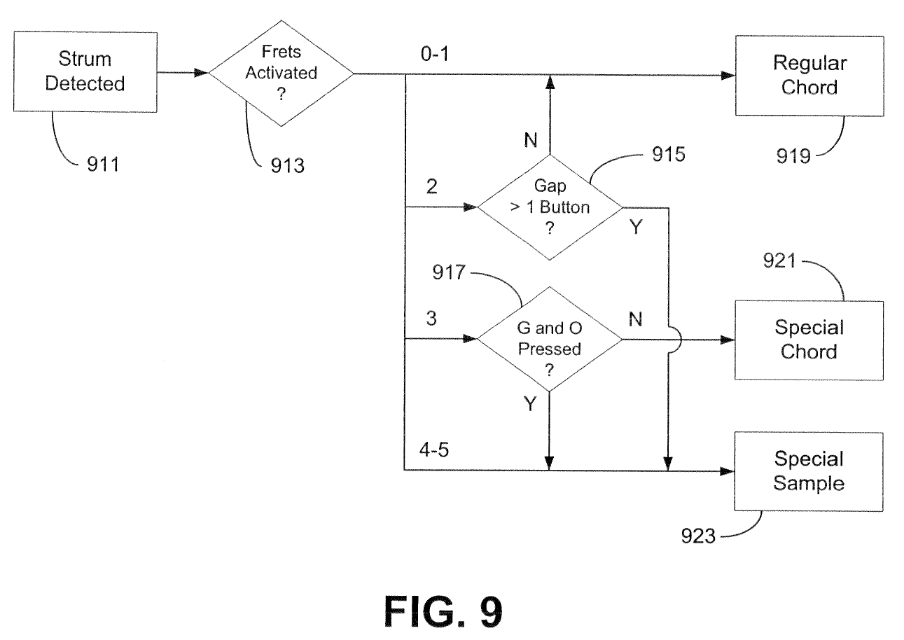

FIG. 9 is a modified flow diagram of a process for selecting audio output type based on the number and arrangement of activated fret inputs in accordance with aspects of the invention. The process may be performed, for example, by a video game console, a processor of the video game console, or some other processor. In some embodiments, the modified flow diagram of FIG. 9 applies to fret input combinations for a guitar shaped video game controller used in conjunction with a music/rhythm video game. In some embodiments, FIG. 9 partially summarizes the fret combination mapping tables of FIG. 8, grouping all possible fret input combinations into one of three categories of audio output types, regular chords, special chords, or special audio samples. FIG. 8 may be referred to for a more detailed analysis of specific chord associations for each individual fret combination.

In block 911, the process detects a strum input and receives an input set corresponding to the status of all the inputs associated with a video game controller at the time of the strum. In most embodiments of the invention, the input sets generated when strum inputs are detected in block 911 are generated through the same process as input signal generation described in the process of FIG. 7. The input set includes information on the fret inputs activated at the time of the strum. The input set may also include status information on various other types of inputs from the video game controller, although the various other types of inputs are not factored into the audio output type selection process of FIG. 9.

In block 913, the process determines the number of frets that were activated at the time of the strum. The embodiment of FIG. 9 corresponds to a guitar shaped video game controller with five fret inputs, although it is recognized that similar modified flow diagrams may be constructed for guitar shaped video game controllers with less or more than five fret inputs, or alternatively for other types of video game controllers with different types of inputs.

If zero or one fret inputs are activated at the time of the strum, the process proceeds to block 919, and the audio output is in the form of a regular chord. As discussed earlier, the zero and one fret input combinations may be reserved for beginner users, and as they do not comprise a complete octave of chords, may become obsolete as a user improves his video game play.

If two fret inputs are activated at the time of the strum, the process proceeds to block 915. In block 915, the process determines whether the gap between the two activated fret inputs is greater than one input button. If the gap between the two activated fret inputs is less than or equal to one fret input button, the combination is classified as an easy two fret input combination. The process proceeds to block 919, and a regular chord is outputted. If, however, the gap between the two activated fret inputs is greater than one fret input button, the combination is classified as a difficult two fret input combination. In these instances, the process proceeds to block 923, and a special audio sample is outputted instead.

If three fret inputs are activated at the time of the strum, the process proceeds to block 917. In block 917, the process determines whether the two fret inputs farthest away from each other are activated. In the embodiment of FIG. 9, the two fret inputs farthest away from each other are the green fret input and the orange fret input. If the green and orange fret input buttons are not both activated at the time of the strum, the combination is classified as an easy three fret input combination. The process proceeds to block 921, and a special chord is outputted. If, however, the green and orange fret input buttons are both activated at the time of the strum, the combination is instead classified as a difficult three fret input combination. The process proceeds to block 923, and a special audio sample is outputted.

If four or five fret inputs are activated at the time of the strum, the process proceeds directly to block 923, and a special audio sample is outputted for all of the four and five fret input combinations, which may all be categorized as difficult fret combinations.

With the audio output type selection process of FIG. 9, the easiest fret combinations to execute are assigned the regular chord outputs, and are generally executed the most often since regular chords are played the most often. Special chords are used less frequently than regular chords, and the fret input combinations associated with special chords are consequently slightly more difficult to execute than the fret input combinations associated with the regular chords. Finally, fret input combinations associated with the special audio samples are the most difficult to execute. As special audio samples are typically used more sparingly during video game play, the fret input combinations associated with the special audio samples may be seen as difficult “bonus” fret input combinations, which can be executed more frequently by skilled users.

FIG. 10 is an illustration of a guitar shaped video game controller with position related input in accordance with aspects of the invention. The guitar shaped video game controller 1011 may be used in, for example, a music/rhythm video game. In some embodiments of the invention, an accelerometer input, or similar tilt sensor input, may be used to increase the number of possible input combinations without the introduction of additional fret inputs or new depressible inputs,

In a typical embodiment, an accelerometer located in a guitar shaped video game controller detects the position or tilt angle of the video game controller. The accelerometer generates an input signal with information related to position or tilt angle of the video game controller. The tilt angle may be defined as, for example, the vertical angle 1013 created by a neck 1015 of the video game controller in relation to a reference 1017 parallel to the floor or ground. In a preferred embodiment, the position information will detect the tilt angle of the video game controller, and determine which one of four predefined quadrants the tilt angle falls within. FIG. 10 illustrates an example of a quadrant configuration in one embodiment of the invention. In this embodiment, a first quadrant 1019 may be considered a high tilt angle quadrant, comprising tilt angles above a positive predefined angle 1021, for example, 40 degrees above a ground reference. A second quadrant 1023 may comprise tilt angles ranging from a reference parallel to the ground up to the positive predefined angle. A third quadrant 1025 may comprise tilt angles ranging from parallel with the ground down to a negative predefined angle 1027. In many embodiments, the negative predefined angle is congruent adjacent to the positive predefined angle, extending the same angular distance below the reference parallel to the ground. In these embodiments, the third quadrant may be characterized as a negative mirror image of the second quadrant. A fourth quadrant 1029 may comprise tilt angles below the negative predefined angle, as illustrated in FIG. 10. In various other embodiments, the quadrants may be differently arranged or defined. In yet other embodiments, more or less than four tilt regions may be defined in various different arrangements, and the tilt angle may be categorized using any potential tilt region configuration.

In embodiments of the invention represented by FIG. 10, tilt position information may be utilized in a variety of different ways. In some embodiments, quadrant information may be used to determine the octave range of the audio output generated by the video game controller. For example, the second and third quadrants may represent a high octave and a low octave, respectively, the two octaves comprising an octave range where most chords will generally be played. In these embodiments, the first quadrant may represent an octave above the high octave, and the fourth quadrant may represent an octave below the low octave. These two latter quadrants may be utilized less frequently. This would facilitate more frequent playing of the guitar shaped video game controller positioned in the relatively more comfortable second and third quadrants during the majority of video game play. In other embodiments, the quadrant to octave association may be more counter-intuitive, where the higher quadrants represent lower octaves, and the lower quadrants represent higher octaves.

In some embodiments octave range changes during video game play may not be changed strictly through tilt information, as has been described with respect to FIG. 10. Other input devices, for example, predetermined input devices on the existing video game controller, or for example, peripherals which plug into or otherwise communicate with and provide additional input signals to the video game controller, may be associated with in-game octave changes as well. One example of a peripheral may be a foot pedal or rheostat pedal compatible with the video game controller. Thus, for example, depression of the foot pedal may result in change of octave from a first octave to a second octave, with depressions of the foot pedal generally resulting in sequencing, possibly in a looping manner, through a sequence of octaves. An additional example of an alternate input device may be a pointer or location sensor on the video game controller.

In other various embodiments, tilt position information may contribute to audio output generation in ways other than determining octave range. Some embodiments may not apply a four octave range, and one or more quadrants may be reserved for special chords or other special audio outputs. For example, in some embodiments, the video game controller may be used to generate input signals consistent with acoustic chord outputs when the video game controller is positioned in the first octave. In other various embodiments, tilt position information may simply be utilized as an additional input, thereby increasing the number of input combinations as was described with respect to FIG. 8 and FIG. 9. In some embodiments, a tilt position indicator may be displayed in a video game play interface to indicate the current tilt region or quadrant the video game controller is positioned.

FIG. 11 is a screenshot of an audio track editing screen in accordance with aspects of the invention. In the embodiment of FIG. 11, the audio track editing screen provides functions for editing specific notes and chords in created audio tracks. The audio track editing screen may be a visual representation of an Advanced Recording Studio, or similar advanced recording feature in the invention, The Advanced Recording Studio may expand upon some of the editing functions included in the FIG. 3 interface, or may introduce new editing functions for editing audio tracks.

In most embodiments, and as is the case in FIG. 11, the audio track editing screen provides editing functions to be applied to a single audio track at a time, the audio track representing the audio output generated by one simulated instrument. In the embodiment of FIG. 11, the audio track currently being edited is the rhythm guitar audio track created by player 1. An indicator 1101 at the top left of the screen indicates to the player whose audio track is being edited, and provides for changing the selected instrument, for example, through activation of predefined inputs on a connected video game controller. Below the indicator is an instrument panel 1103 with configuration information pertaining to the selected instrument. The instrument panel may mirror the instrument panels provided for each simulated instrument in FIG. 3, and may include information on, for example, the root note and scale of the selected instrument 1105, as well as the current octave range of the selected instrument 1107.

An instrument highway 1109 of the audio track of the selected instrument is prominently displayed at the center of the screen. The instrument highway is a visual representation of the audio track, with a vertical axis representing time elapsed in the audio track, and a horizontal axis representing fret input combinations for guitar-type instruments or similar inputs or input combinations for other instrument types such as drums. In embodiments of the invention using guitar shaped video game controllers with five fret inputs, the horizontal axis may be divided into five separate color coded sections 1111, each color coded section representing one of the five fret inputs. Colored gems, for example, gems 1113, may be displayed in each color coded section corresponding to the fret inputs being activated on the video game controller. In some embodiments, the color of each colored gem may match the actual color of the corresponding fret input as it appears on the video game controller. Each horizontal set of gems may represent a fret input combination used to generate a chord being played at a particular time in the audio track. By displaying individual gems representing each fret input and fret input combination, the editing of each individual fret input is more easily facilitated.

In some embodiments, for example, the embodiment of FIG. 11, additional instrument highways 1115 may be visualized in the editing screen. The additional instrument highways may represent the audio tracks of the other simulated instruments in a song compilation, and may be provided as a resource or reference in the audio track editing process. Labels beneath each instrument highway indicate which simulated instrument is associated with each instrument highway, for example, the second instrument highway represents the audio track of the lead guitar 1117, and the third instrument highway represents the audio track of the bass guitar 1119. In most embodiments, visualization of the additional instrument highways may assist in integration of the selected instrument highway with the rest of the song, but edits may still only be applied to the selected instrument highway. Therefore, the additional instrument highways are displayed less prominently to the right of the selected instrument highway, and are visualized as thinner or more compressed than the selected instrument highway. Changing the selected simulated instrument by, for example, changing the selected instrument indicator at the top left of the screen, may enlarge the instrument highway of a newly selected simulated instrument and permit editing to that instrument highway, while the size of the instrument highway of the previously selected simulated instrument may be reduced. In some embodiments, the positions of the instrument highways may also be swapped, thereby centering or more prominently displaying the new instrument highway to be edited.

Various general playback and editing functions 1121 may also be provided in the audio track editing screen of FIG. 11. To the left of the selected instrument highway are provided a column of playback function icons, for example, icons representing play, record, rewind, and fast forward functions, among other possible playback functions. Also provided are icons for a number of simple editing functions, for example, delete, copy, and paste functions. More or less general playback and editing functions may be provided in different embodiments of the invention. In most embodiments of the invention, the playback and editing functions are applied to the selected instrument highway when activated. In certain other embodiments, particular types of playback and editing functions may be applied to all of the instrument highways, representing a universal change to all the audio tracks at a particular time in a song compilation.

More advanced editing features may also be provided in the audio track editing screen. For example, along the far left side of the screen in FIG. 11 are additional panels indicating the recording status 1123, a “snap to” option 1125 which adjusts the instrument highway displays, and the amount of available memory used and remaining for the particular track or song 1127. In some embodiments, speed or tempo changes may also be applied mid-song. The “snap to” panel in FIG. 11 is an instrument highway display setting, and indicates that the instrument highways are currently configured to display 1/16 of a bar of music at a time. The setting may be adjusted so that less of each audio track, for example, 1/32 of a bar of music, or more of each audio track, for example, ¼ of a bar, ½ of a bar, or one entire bar of music, are displayed by the information highways, depending on user preference. In other embodiments of the invention, more, less, or different editing options may be provided for selection on a provided audio track editing screen.

FIG. 12 is a flow diagram of an audio track editing process in accordance with aspects of the invention. In particular embodiments of the invention, the process is performed in the Advanced Recording Studio of a music/rhythm video game, and the screenshot of FIG. 11 may represent a user interface in which the process of FIG. 12 is performed. In exemplary embodiments of the invention, the process is used to edit individual audio tracks of created or recorded songs, but in other various embodiments, similar processes may be applied for editing of other types of material in the context of other video games.

In block 1211, the process performs audio track selection. The process provides for selection of a song, and subsequent selection of a particular audio track within the selected song. In most embodiments, each audio track of a song may represent an audio output generated from input signals received from one instrument in the context of a song compilation including audio tracks for a plurality of instruments. In some embodiments, only audio tracks created or recorded earlier through, for example, the audio generation and recording process of FIG. 7, may be available for selection and subsequent editing. In other embodiments, audio tracks from preloaded songs may also be available for editing or modification. An instrument highway representing the audio track selected for editing may be displayed in a video game interface, for example, the interface of FIG. 11. An instrument highway for a guitar video game controller may include information on strum times and fret input combinations at the strum times. An instrument highway for a drum set video game controller may include information on different drum beats or strikes in the context of the song compilation.

In block 1213, the process performs instrument highway editing. As discussed above, in embodiments of the invention, each instrument highway is a visual representation of an audio track for a selected instrument, and may include, for example, information on the time of each strum input in the context of the song, and the fret input combinations at the time of each strum. The information may be visualized in a variety of different formats, but preferred embodiments includes five vertical columns, each column representing a different fret input, with the vertical axis representing the elapsed time in the song. A gem or similar visual marker is displayed for each activated fret input, with a horizontal collection of gems along the instrument highway comprising a fret input combination at the time of each strum. The vertical columns and gems in some embodiments are color coded to match the fret input buttons on the guitar shaped video game controller.

The process may provide different editing options for editing an instrument highway. Editing options may include a recording function, where an audio track may be recorded in a process similar to the audio generation and recording process of FIG. 7. A step recording function may also be provided, wherein fret input combinations are entered on a chord-by-chord basis, gem sequences being created for each fret input combination, and timing of the fret input combination within the context of the song may all be manually adjusted using a video game controller. Other editing functions, for example, copy, paste, and delete functions, may be provided to assist in editing the gems in the instrument highway. In most embodiments, playback features, for example, play, fast forward, rewind, and stop/pause, are also provided for easy navigation or audio previewing of the audio track being edited. In some embodiments, other aspects of playback, for example, special effects such as fireworks or lightshow cues during video game play, may also be added into the instrument highways to enhance visualization of the audio track or song. In some embodiments, more detailed lighting features, for example, spotlights on the stage, may be controlled and focus on different subjects at different points in the song. In various other embodiments, more, less, or different editing functions may be provided.

In block 1215, the process determines whether to save the edited instrument highway. If the process determines that the edited instrument highway is not to be saved, the process proceeds to block 1221, where the process determines whether to exit.

If the process determines to save the edited instrument highway, the process proceeds to block 1217. In block 1217, the edited instrument highway is saved into memory, for example, a main memory in the video game console. As only one instrument highway associated with one selectable instrument has been edited and saved, the edited instrument highway is integrated into the song from which it was retrieved, and the song with the edited audio track successfully integrated, may then be played. In some embodiments, information used to generate the instrument highway, for example, information on strum times and fret input combinations at each strum, may instead be saved into memory. In some embodiments, strum and fret combination information may more readily be converted into either playback or editing formats, and storage in this form may be more versatile, and therefore more desirable.

In block 1219, the process assigns a new difficulty level to an edited instrument highway. Each instrument highway may be assigned a difficulty level of easy, medium, hard, or expert, based on a number of different factors, and represents the relative difficulty of successfully playing through the song in video game play. A difficulty designation may depend on a variety of factors, for example, the number of fret buttons used, the difficulty of fret input combinations and distance between successive fret combinations, and the speed of the song. An instrument highway which has been edited may be more difficult or less difficult to play through in video game play than the instrument highway was before editing, depending on the types of edits incorporated. The newly edited instrument highway is designated with a new difficulty level based on the above discussed criteria, and possibly other criteria in other embodiments. The new difficulty level gives users a general idea of the relative skill level needed to successfully complete playback of the version of the instrument highway as created or edited.

In block 1221, the process determines whether to exit advanced audio track editing. If the process determines not to exit, the process returns to block 1211, where the same instrument highway or a different instrument highway may be selected for editing. If the process determines instead to exit advanced audio track editing, the process returns.

FIG. 13 is a block diagram of a system for uploading and downloading recorded or edited audio tracks or songs via the Internet in accordance with aspects of the invention. The audio tracks or songs may be associated with, for example, a music/rhythm video game, and may initially be created and stored onto memory allocations in individual video game consoles 1311, through the processes of the invention as have been described herein. A plurality of video game consoles may be playing the same music/rhythm video game simultaneously, and each video game console may provide connectivity to the Internet 1313. An internet connection may be desirable to facilitate multiplayer game play with other users of the video game in remote locations, or for uploading and downloading various media associated with the video game, for example the audio tracks or songs described above. In some embodiments, some of the plurality of video game consoles may be connected to the Internet via wireless connections.

Audio tracks or song compilations generated through processes of the invention may be shared between video game consoles in different locations via the Internet or in some embodiments, with an external storage device. In some embodiments of the invention, an upload feature may be provided in the context of video game play, facilitating transfer of audio tracks or songs from a first video game console to a remote server 1315 via the Internet. The server may have memory allocations dedicated to storage of the audio tracks or songs in association with a particular video game, and may include controls for user access and content. In other embodiments, media sharing may be executed peer-to-peer, that is, a first video game console may connect directly with a second video game console to transmit audio tracks, songs, or other audio associated data to the second video game console. Generally, in the context of the music/rhythm video game of the invention, entire song compilations including detailed audio and video output information is not saved or transferred, as the files would be too large. Instead, transmitted information may include input set information as was described with relation to FIG. 7, or other forms of data or information, to facilitate recreation of an audio track or collection of audio tracks based on templates stored in the removable memory source for each separate console, which holds video game instructions. In some of the embodiments, the upload feature may be offered for each newly created audio track only after satisfaction of certain prerequisites associated with the audio track. For example, the creator or editor of a new audio track may be required to successfully complete a play through of the new audio track in video game play with a certain accuracy or compliance rate before uploading the new audio track.

In embodiments of the invention using a server to facilitate uploading and downloading of materials associated with video game play, other video game consoles may download and retrieve a particular uploaded audio track or song from the server upon request for the audio track or song. Uploaded material may be listed in many different arrangements, for example, newest uploaded material or most downloaded material, or be grouped into categories such as, for example, difficulty level or geographic area of origin. After downloading of information associated with a particular audio track or song is complete, the processor of the downloading video game console may reconstruct the information into, for example, the complete audio track or song based on templates retrieved from video game information. In most embodiments of the invention, once an audio track or song has been reconstructed, further edits and additions may be made to the audio track or audio tracks included in a song. Audio tracks or songs including the further edits and additions may be re-uploaded to the server, providing access to the edited audio tracks or songs to other video game users for possible download and additional editing.

FIG. 14 is a flow diagram of a collaborative editing process in accordance with aspects of the invention. In some embodiments, the process is performed in the context of a music/rhythm video game as has been previously described. The process provides a forum for peers to improve upon user created audio tracks and songs by editing, making additions to, or removing portions from the audio tracks and songs. The collaborative editing process may be performed in conjunction with the upload/download arrangement as illustrated in FIG. 13.

Often, it may be simpler to edit individual audio tracks of an already existing song because a melody has already been established for the song, and edits may be structured to fit within an already existing framework created by accompanying audio tracks in the song. Further, many users of the video game may be single players, and it may be overly burdensome to create an entire song compilation including multiple audio tracks by generating and recording each individual audio track separately. The collaborative editing process of FIG. 14 provides a process for users to collaborate with other users in remote locations to generate and contribute to a joint song compilation comprising multiple audio tracks, creating an aura of team play even for players who may physically be playing alone.

In block 1411, the process provides for selection and downloading of an editable audio track or song. Downloadable songs may be arranged and offered in various leaderboard formats, or may, for example, be offered based on connections made through friend searches between two particular video game consoles owned by different users. Downloaded songs may either be played back in video game play, and in certain instances, may also be edited. In certain embodiments of the invention, a user created audio track may be locked by its creator, preventing other users from making edits to the song. Locked audio tracks may still be uploaded and downloaded. However, locked audio tracks which are downloaded may be limited to replay or playback, and editing features may not be available for locked audio tracks.

Through song playback, users are given the opportunity to play through new songs created and edited by fellow users of the video game. Playback of a downloaded song involves playing the downloaded song and using an appropriate video game controller to comply with user instructions included in the downloaded song. Providing a forum for song sharing essentially creates a limitless number of songs to choose from and play through, and offers new challenges and replay value to, for example, users who have completed the game, or for example, users who have gotten bored of the selection of songs preloaded onto the video game medium. In some embodiments, playback may only allow for a single guitar track, for example, in embodiments where playback includes tracks for a guitar, a bass guitar, drums, and a vocalist. In these embodiments, the process may automatically combine lead guitar and rhythm guitar tracks from a created or edited song, for purposes of playback. The process may select portions of gem sequences from the guitar and rhythm guitar tracks to generate a combined guitar track for users to play through in these embodiments.

In certain playback embodiments, the process may provide users an option of selecting different difficulty levels of downloaded songs for playback. While a creator or editor of the song may have only generated one version, corresponding to one difficulty level, of a song, some embodiments of the invention provide for automatic difficulty scaling, enhancing or reducing a song's difficulty level based on user preference. The process may automatically adjust the gem sequences of a selected song for playback, so that the song falls within predefined difficulty limits based on, for example, number of frets used and difficulty of fret combinations and fret combination sequences.

Editable song tracks, that is, audio tracks which are not locked from editing, may be categorized separately from the locked audio tracks on a server storing uploaded audio tracks and song compilations. Editable song tracks may be downloaded to video game consoles, and may serve as a starting point or song template for other users of the video game to try and improve or enhance. Some video game players may prefer to make additions to already existing audio tracks or songs rather than create an audio track or song from scratch, which may be a difficult task to accomplish, especially for more novice or beginner players of the video game. Before download, each song is assigned a song ID, for example, a 64 bit file ID, which identifies the song from its initial creation, and throughout edits made by either the original author or other users. Therefore, a second user may not be able to download a song made by a first user, and upload the same song later and claim it as his or her own.

In block 1413, the process provides for audio track editing and storage. In most embodiments, audio track editing and storage is similar to the audio track editing process as described with regards to FIG. 12. In some embodiments, additional tracks may be created and added to a song compilation, generating either a new audio track from a new instrument or an additional audio track from an instrument already in use in the original song compilation, for example, a second guitar audio track. In these instances, the audio track editing and storage process may closely mirror the process as described with regards to FIG. 7. Some embodiments may also provide functions for removing entire tracks or certain parts of particular tracks from a song compilation.

In block 1415, the process requires a creator or editor of an audio track to successfully play through the audio track or song in video game play. The play through requirement may be established as a filter to prevent creators or editors from uploading audio tracks which are overly difficult, or even impossible, to successfully play through. An example would be to require a creator of a song to play through the created song with 80% accuracy before allowing the song to be uploaded. Similar other prerequisites may be established for each newly created or edited audio track to filter uploaded content for various different reasons. In some embodiments of the invention, there may be no prerequisites for uploading content onto the server, and any created or edited audio track may qualify for uploading for other users to access and download.

In block 1417, the process performs uploading of a created or edited audio track or song. In embodiments with no uploading prerequisites, audio tracks or songs may be uploaded immediately after creation or edits have been made to the audio tracks or songs. In embodiments with uploading prerequisites, the uploading prerequisites must be satisfied before an uploading feature may be accessible for the newly created or edited audio track or song. In most embodiments, copies of original songs remain on the server, providing for downloading and saving of new and edited versions of each song, while also retaining original and older versions of the songs on the server. The older versions of a particular song therefore remain accessible for users who prefer an older version over a newer version. Such an arrangement also allows users to freely upload their material without having to worry about other users permanently editing their created songs in undesirable ways.

In some embodiments, users are provided options to create bands or share/collaboration groups with other users. In some embodiments, band or group members may generate or create album cover art for the band or group. Some embodiments of the invention may suggests peer users which may be suitable collaborators for each user based on, for example, favorite genre, or for example, user ranks based on various criteria.

FIG. 15 is a screenshot of a leaderboard including downloadable songs in accordance with aspects of the invention. The screenshot includes a main leaderboard 1501, with a list of songs and information about the songs, for example, a song title, a song rating, the creator of the song, the genre of the song, and a difficulty level of the song. A featured song is highlighted and shows on a display 1503 above the leaderboard. For example, the featured song in FIG. 15 is “Bingo Bango” by Mr. Peanut and the Gallery. The featured song may be, for example, the highest rated song or, for example, a random song selected from the currently displayed leaderboard.

Different leaderboards may provide lists of different downloadable songs. In FIG. 15, a list 1505 of different available leaderboards is displayed. The currently selected leaderboard is the “HOT THIS WEEK” leaderboard. This may correspond to a leaderboard of, for example, the top rated songs of the week. Leaderboards may also be sorted by, for example, top artists, specially showcased songs, browsed songs, all time best songs, and rising stars. Many of these leaderboards may be arranged by a song rating, from best rating to worst rating. However, the songs may also be arranged in a variety of other ways, for example, alphabetically by title, or be grouped into, for example, different genres or difficulty levels. In FIG. 15, a plurality of icons appears at the top of the screenshot. The icons may correspond to, for example, different download or preview functions. Alternatively, the icons may be visual representations of the different available leaderboards.

File uploads may be monitored on the server side, for example to regulate bandwidth usage. In most embodiments, different prerequisites and limits are established to prevent overload of a server dedicated to storing the different information of all the user uploaded songs. For example, as was described with respect to FIG. 13, file sizes of uploads may be limited, compressed in many embodiments to as little as 60 kb per file. The information stored for each song or track is generally limited to input sets representing notes, the timing of all the input sets, and instrument configuration information. Templates may be stored on the removable memory source, for example the video game CD-ROM inserted into each video game console. After a compressed file is downloaded onto a particular console, the compressed file is reconstructed using the templates, and the audio and video presentation is recreated in full locally in each video game console.

Furthermore, the number of file uploads allowed for each user or console may also be limited. In one embodiment, users are initially allowed to upload, for example, five separately created files. Each created file is assigned a song ID, and the song ID is added to a list on the server identifying the user's uploaded songs. If a user has reached his upload limit, he may be asked to delete a file before being allowed to upload any additional files. In some embodiments, users may be allotted additional upload privileges based on, for example, the quality of the user's uploaded songs. If a user's five songs are received well by other users, or receives high ratings, the upload limit may be increased for the user to, for example, twenty or fifty songs. In these embodiments, a hard limit is still typically established, meaning a user will not be allowed to upload more than a certain number of files, for example, fifty files, under any circumstances.

In some embodiments, a removed files leaderboard or database may also be available. A removed files database may serve as a backup in case files are accidentally deleted or removed. In some embodiments, the removed file database may serve as an integrity check to make sure deleted or removed files are not reuploaded by users and unnecessarily take up server space or clog bandwidth.

In FIG. 15, each song has also been assigned a rating 1509. The rating is a Bayesian rating, and reflects a combination of a server side rating of the song and user ratings of the song. Under current embodiments of the invention, the rating system rewards songs for both high ratings and high volume of ratings. The rating system is generally based on a five point scale, from zero to five, and provides for ratings using half points. Therefore, in the screenshot of FIG. 15, “Bingo Bango” currently has a rating of 5 out of 5, while “Over Here” currently has a rating of 1.5 out of 5.

FIG. 16 is a screenshot of a song preview interface in accordance with aspects of the invention. In many embodiments, FIG. 16 may be illustrative of an extension or a pop-up selection of the screenshot of FIG. 15. For example, FIG. 16 may represent a screenshot after the song “Let's Jam” from FIG. 15 is selected from the leaderboard. An information window 1601 may be prominently displayed, and may include detailed information on the selected song “Let's Jam.” Additional detailed information may include, for example, a song rating 1603, a creator 1605, a band or song logo 1607, other contributors or collaborators 1609, the number of ratings the song has received 1611, a song genre 1613, and a list of tracks that have been created for the song 1615. In some embodiments, a summary data page may be provided, including specific song information, for example, root note and scale of the song, or for example, specific settings of each instrument.

A playback timeline 1617 and a plurality of icons providing playback and saving functions may also be displayed on the preview screen. For example, a play/pause icon 1619 and a save icon 1621 are among the different icons displayed on the preview screen of FIG. 16. Users may select a song, and preview the song before deciding whether to download it. In some embodiments, users may also be given an option to rate songs which they preview, and contribute to the overall rating of the song. In some of these embodiments, a rating may be a prerequisite to downloading the song after it has been previewed, to encourage users to listen to and rate files, and to increase the sample sizes associated with the ratings system.

The invention therefore provides for configurable instruments and recording functions for a video game, for example, a music/rhythm video game. Although the invention has been described with respect to certain embodiments, it should be recognized that the invention may be practiced other than as specifically described, the invention comprising the claims and their insubstantial variations supported by this disclosure.

What is claimed is:

1. A method of generating user instruction note tracks for a music based video game, comprising:
receiving video game controller inputs over time, the video game controller simulating a musical instrument, the video game controller inputs representative of simulated play of the simulated musical instrument;
storing an indication of the video game controller inputs, an indication of time of receipt of the video game controller inputs, and a representation of audio associated with the video game controller inputs;
generating display information for visual display of a representation of the received video game controller inputs over time.

2. The method of claim 1 further comprising commanding display of the display information.

3. The method of claim 1 wherein audio associated with the video game controller inputs is based on a selection of a song.

4. The method of claim 3 wherein different audio is associated with each of a plurality of video game controller inputs.

5. The method of claim 4 wherein different audio is associated with each of a plurality of different combinations of video game controller inputs.

6. The method of claim 1, further comprising receiving a selection of a root note, and audio associated with the video game controller inputs is based on the root note.

7. The method of claim 1, further comprising receiving a selection of at least one chord set, and audio associated with the video game controller inputs is based on the chord set.

8. The method of claim 1, further comprising receiving simulated musical instrument configuration information, and audio associated with the video game controller inputs is based on the configuration information.

9. The method of claim 2 wherein the display of the display information includes markers indicative of video game controller inputs.

10. The method of claim 9 wherein the markers indicative of video game controller inputs provide user instruction information.

11. The method of claim 10 further comprising determining if a user complies with the user instruction information during display of the display information.

12. The method of claim 11 further comprising commanding audio generation of the audio associated with the video game controller inputs if the user complies with the user instruction information.

13. The method of claim 11 wherein the markers are displayed in a track, the markers moving within the track, with markers in a predefined area of the track providing user instruction information for a user to manipulate video game controller inputs in accordance with information provided to the user by the markers.

14. The method of claim 13 wherein the video game controller simulates a guitar.

15. The method of claim 14 wherein the markers are indicative of fret button inputs of the video game controller.

16. The method of claim 13 wherein the video game controller simulates a drum set.

17. The method of claim 16 wherein the markers are indicative of drum head inputs of the video game controller.

18. The method of claim 1 wherein a beat is associated with the indication of time of receipt of the video game controller inputs.

19. The method of claim 18 wherein the indication of time of receipt of the video game controller inputs is quantized to the beat.

20. The method of claim 1 further comprising receiving additional video game controller inputs from an additional video game controller over time, the additional video game controller simulating a further musical instrument, the additional video game controller inputs representative of simulated play of the further simulated musical instrument;
storing an indication of the additional video game controller inputs, an indication of time of receipt of the additional video game controller inputs, and a representation of audio associated with the additional video game controller inputs;
generating additional display information for visual display of a representation of the received additional video game controller inputs over time.

21. The method of claim 20 further comprising commanding display of the display information and the additional display information.

22. The method of claim 21 wherein the display information and the additional display information includes markers indicative of the video game controller inputs and the additional video game controller inputs, the markers providing user instruction information for a plurality of users.

23. The method of claim 22 further comprising determining if the plurality of users comply with the user instruction information.

24. The method of claim 22 wherein the further video game controller simulates a further guitar.

25. The method of claim 22 wherein the further video game controller simulates a drum set.

26. The method of claim 20 wherein the video game controller inputs are received by a first game console and the further video game controller inputs are received by a second game console.

27. The method of claim 23 wherein the video game controller inputs and the further video game controller inputs are received by at least one of a plurality of game consoles and determining if the plurality of users comply with the user instruction information is performed by at least one of a further plurality of game consoles.

28. A method of generating a visual representation of video game controller operations for use in a music video game, comprising:
receiving an input sets from a video game controller simulating a guitar, the video game controller including a plurality of fret inputs and a strum input, the input sets including an activated strum input and activated fret inputs at the time of the activated strum input;
storing an indication of the activated fret inputs and a representation of time of activation of the strum input;
commanding display of markers in a track, the markers indicative of activated fret inputs, the markers arranged in the track according to time of activated strum input.

29. The method of claim 28, wherein the track has a width about an axis defined by a length of the track, and the axis defined by the length of the track represents elapsed time.

30. The method of claim 29, wherein markers associated with a particular activation of strum input are displayed along the width of the track.

31. The method of claim 28, wherein the marker for each fret input is a colored gem, a color of the colored gem corresponding to a color of a corresponding fret input of the plurality of fret inputs on the video game controller.

32. The method of claim 28, wherein the markers arranged in the track form a visual representation of an audio feature.

33. A method for modifying song information for a music video game, comprising:
receiving a listing of songs, the listing of songs available from a computer accessible via the Internet;
selecting a song from the listing of songs, the selected song including a plurality of editable song tracks;
downloading the selected song via the Internet to a local memory;
modifying at least one of the plurality of editable song tracks to generate an edited song by operating inputs of a video game controller, with different audio being associated with different inputs and different combinations of inputs of the video game controller; and
storing the edited song.

34. The method of claim 33, wherein modifying at least one of the plurality of editable song tracks includes generating a new song track.

35. The method of claim 33, further comprising uploading the edited song to a computer accessible via the Internet.

36. The method of claim 35, further comprising meeting a set of prerequisites before uploading the edited song.

37. The method of claim 36, wherein the set of prerequisites includes successfully playing through the edited song in a game play mode of the music video game.

38. The method of claim 33, wherein the listing of existing songs is arranged in a leaderboard format.

39. The method of claim 38, wherein the order of the leaderboard is based on an average user rating calculated from a plurality of user ratings.

40. The method of claim 33, wherein each existing song in the listing of existing songs is uploaded to the Internet by a user of the music video game.

41. A system for providing a recording interface for recording audio information for a video game comprising:
a display;
at least one video game controller;
memory, the memory including adjustable audio parameters of simulated instruments associated with each of the at least one video game controllers;
a processor configured by program instructions to generate display information of the recording interface, the program instructions including instructions for:
providing adjustment options for the audio parameters;
applying the audio parameters to a sequence of inputs from the at least one video game controller to generate at least one sequence of audio outputs; and
providing a recording function for recording the sequence of inputs and the audio parameters.

42. The system of claim 41, wherein the program instructions include program instructions for commanding display of information regarding the audio parameters for each simulated instrument in the recording interface.

43. The system of claim 41, wherein the program instructions further include program instructions for providing editing options for editing the sequence of inputs.

44. The system of claim 41, further comprising a further recording feature for recording and editing information associated with individual inputs in the sequence of inputs.

45. The system of claim 44, wherein the further recording feature includes a second interface comprising a visual representation of the sequence of inputs.

46. The system of claim 44 wherein the further recording feature includes an option to change the tempo at which the audio outputs are played.

47. The system of claim 41, wherein the adjustment options for the audio parameters include options for adjusting a root note, adjusting a scale, adjusting an octave range and adjusting audio effects.

48. The system of claim 47, wherein the adjustment options for the audio parameters further includes an option for adjusting video effects.

49. The system of claim 41, further comprising an upload feature, wherein the processor is configured by program instructions to upload the sequence of inputs over the Internet.

50. The system of claim 49, wherein the program instructions further include program instructions for generating a second sequence of audio outputs based on a second sequence of inputs and for uploading the second sequence of inputs along with the sequence of inputs.

51. A method of generating a collaborative audio feature in a multiplayer music video game, comprising:
receiving a selection of a simulated instrument for each of a plurality of video game controllers;
adjusting audio parameters associated with each of the plurality of video game controllers;
receiving a sequence of input sets from each of the plurality of video game controllers;
generating a plurality of audio output sequences, each audio output sequence generated from a sequence of input sets from a one of the plurality of video game controllers and the audio parameters associated with the one of the plurality of video game controllers.

52. The method of claim 51, further comprising storing the collaborative audio file.

53. The method of claim 52, wherein the stored collaborative audio feature is assigned a difficulty level.

54. The method of claim 51 wherein selectable simulated instruments include guitar-type simulated instruments.

55. The method of claim 51 wherein selectable simulated instruments include simulated drum sets.

56. The method of claim 51 wherein selectable simulated instruments include microphones.

57. The method of claim 56, wherein microphone input sets comprise pitch information.

58. The method of claim 51, wherein each selectable simulated instrument includes initial default audio parameters.

59. The method of claim 51, wherein selecting a simulated instrument further comprises selecting a preloaded song.

60. The method of claim 59, wherein each select simulated instrument includes an initial set of audio parameters corresponding to audio parameters applied to the simulated instrument in the selected preloaded song.

61. The method of claim 51, further comprising uploading the collaborative audio feature over the Internet.

62. The method of claim 61, further comprising downloading and editing the collaborative audio feature, and uploading the edited collaborative audio feature.

63. The method of claim 61, further comprising meeting a set of prerequisites before uploading a collaborative audio feature.

64. A method for configuring a simulated musical instrument in a music based video game system, comprising:
receiving a selection of a musical instrument based on a signal from a video game controller;
mapping audio parameters to video game controller inputs based on the selected musical instrument;
presenting options for modifying the audio parameters;
receiving requests to implement selected ones of the options; and
implementing the selected ones of the options by modifying the mapping of audio parameters to video game controller inputs.

65. The method of claim 64, wherein options for modifying the audio parameters includes an option for selecting any of a plurality of instrument types of the selected musical instrument.

66. The method of claim 64, wherein options for modifying the audio parameters includes options to apply a plurality of audio effects to mapped audio parameters.

67. The method of claim 66, wherein the options to apply a plurality of effects further comprises options to adjust the strength of each applied effect.

68. The method of claim 64, wherein the musical instrument is a guitar-type musical instrument including a plurality of fret inputs.

69. The method of claim 68, wherein options for modifying the audio parameters includes options to adjust a root note of the guitar-type musical instrument.

70. The method of claim 69, wherein options for modifying the audio parameters further includes options to adjust a scale associated with the root note.

71. The method of claim 68, wherein options for modifying the audio parameters includes options to adjust the octave range of the guitar-type musical instrument.

72. The method of claim 68, wherein modifying the mapping of audio parameters to video game controller inputs further comprises providing an option to separately modify an audio output associated with a plurality of combinations of fret inputs.

73. The method of claim 64, wherein the musical instrument is a drum set comprising a plurality of drum inputs.

74. The method of claim 73, wherein modifying the mapping of audio parameters to video game controller inputs further comprises providing the option to separately modify the audio output associated with each of the plurality of drum inputs.

75. The method of claim 64, wherein the musical instrument is a microphone.

76. A method for generating a simulated guitar chord output in a music based video game, comprising:
receiving status information of a plurality of fret inputs from a video game controller and an indication of video game controller position;
determining a combination of activated fret inputs from the plurality of fret inputs;
determining an audio guitar chord output to output based on the combination of activated fret inputs; and
modifying the simulated guitar chord output based on the indication of video game controller position.

77. The method of claim 76, wherein the indication of video game controller position modifies an octave of the simulated guitar chord output.

78. The method of claim 76, wherein an indication of video game controller position is an indication of an angle of displacement of a neck of the video game controller from a horizontal reference.

79. The method of claim 78, further comprising determining if the indication of the angle of displacement of the neck of the video game controller is in one of a plurality of angular regions.

80. The method of claim 79, wherein there are four angular regions.

81. The method of claim 79, wherein a different octave is associated with each of the plurality of angular regions, the simulated guitar chord output being output at the octave associated with the angular region in which the video game controller is positioned.

82. A method for providing audio outputs for a video game, comprising:
receiving musical instrument related audio parameters associated with a guitar-shaped video game controller, at least some of the audio parameters adjustable using the video game controller;
receiving a strum input from the video game controller;
receiving an input set comprising status information of a plurality of fret inputs of the video game controller when the strum input was received; and
processing the input set and the audio parameters to command generation of an audio output.

83. The method of claim 82, wherein processing of a sequence of input sets with the audio parameters generates an audio feature.

84. The method of claim 83, further comprising generating a collaborative audio feature by combining audio features generated from a plurality of video game controllers.

85. The method of claim 84, wherein the plurality of video game controllers generate the collaborative audio feature simultaneously.

86. The method of claim 82, wherein the audio output is a guitar chord assigned to a combination of activated fret inputs of the plurality of fret inputs.

87. The method of claim 86, wherein the guitar chords assigned to each combination of activated fret inputs can be modified using the video game controller.

88. The method of claim 82, wherein the input set further comprises a position related input corresponding to position information of the video game controller.

89. The method of claim 88, wherein the position related input is used to determine an octave of the audio output.
